(19) United States
(12) Patent Application Publication
(10) Pub. No.: US 2026/0016729 A1
(43) Pub. Date: Jan. 15, 2026

(54) Wireless Building Windows with Variable Light Transmission

(71) Applicant: Glass Dyenamics, Inc., Tucson, AZ (US)

(72) Inventors: Anoop Agrawal, Tucson, AZ (US); Christopher Angelo, Bend, OR (US)

(73) Assignee: Glass Dyenamics, Inc., Tucson, AZ (US)

(21) Appl. No.: 19/269,589

(22) Filed: Jul. 15, 2025

Related U.S. Application Data
(60) Provisional application No. 63/671,637, filed on Jul. 15, 2024.

(51) Int. Cl. G02F 1/153

(52) U.S. Cl. CPC G02F 1/153

(57) ABSTRACT

Energy efficient building windows with variable light transmission panels are disclosed. The focus is on low-cost solution in terms of the type of variable light transmission panels used, installation, maintenance and operation. The windows are not wired to building power sources and are self-regulating to provide energy efficiency, comfort, privacy, and several other useful attributes. The windows are powered by power sources such as solar cells located within each window. These windows can be linked wirelessly for communication. The principles of self-regulation, user interaction, and forming a wireless networks and their operation are disclosed.

### CROSS-REFERENCE TO RELATED APPLICATION

This application claims priority benefit to U.S. Provisional Appl. No. 63/671,637, filed Jul. 15, 2024, the disclosures of which are incorporated herein by reference in its entirety.

### FIELD OF THE INVENTION

This disclosure relates to variable transmission windows (VTWs) which are used for architectural applications.

### BACKGROUND

In the United States, almost 50% of the nation's energy is consumed by buildings, and further half of the energy consumed by buildings is associated with the windows due to heat and light entering through them or being lost through them which impacts heating, cooling and lighting costs. Therefore, there is an unmet need for improved window energy performance.

Being able to dynamically regulate solar radiation (or light) which passes through the windows has been identified as an important property to improve their efficiency. For example, on cold winter days, when it is bright outside and more sunlight is allowed into a building, it reduces the energy required to heat the building from the building's Heating, Ventilation and Air-conditioning (HVAC) system. Similarly, during summer, solar radiation transmission through windows may be reduced on warm bright days so that the air-conditioning mode of the HVAC does not have to consume energy to remove excessive solar heat from inside the building. These problems are particularly acute with modern architectural designs with windows occupying larger areas in a building's envelope. The variable transmission is achieved by integrating electrochromic panels into windows the transmission of which can be varied by applying electrical voltage. Typically, the power source is the building power, and these windows need to be wired. While the concept of wireless VTWs for buildings, where such windows are integrated with solar cells so that they can be powered by them, has been contemplated, such wireless systems are still not commercially available. To date, powering VTWs using solar cells has been insufficient to achieve fully wireless functionality while also saving energy and being available at an attractive cost.

### SUMMARY OF THE INVENTION

This innovation discloses ways to integrate local power sources, such as solar cells and batteries into VTWs, and their use in powering the variable light transmission panels (VLTPs) such as electrochromic (EC) panels. Therefore, these VTWs do not have to be connected (hard-wired) to the building power supply. In one embodiment, these windows are self-regulating independent windows, which means that no external wiring is needed to power these windows for changing their optical properties. To achieve these optical properties, other sensory inputs are required. Such sensory inputs and their integration with VTWs are disclosed herein. For these windows to be truly wireless, they need to act as independent self-regulating units. Furthermore, many of such windows are capable of being wirelessly networked together to share common triggering mechanisms or commands to change the light transmission, even though the power source to trigger the window and wirelessly communicate is located within each window. This power is not shared amongst the windows. It must be recognized that within the same building or a residence there may be several networks or clusters each having a group of windows. Further, such customized networking is possible in the field by a service person, building manager and/or the end-user (e.g., the occupant). In some aspects, these persons may be referred to as the user. There is a preference that the end-user should be able to configure the network at will and arrange different windows in the building to be a part of a particular cluster/network, and this preference may even change with a change in season or with the end-user. This will be discussed in more detail below, but it is sufficient to point out that this feature is also important if a window needs to be replaced, as a user is then enabled by the invention of the present disclosure to seamlessly network this window with other windows and clusters which are already present. The power sources, control systems and any sensors located in the window are integrated for easy repair and replacement without having to remove or change an installed window/insulated glass unit (IGU).

Mechanisms and methods of self-regulation are taught in this disclosure. In another embodiment these windows are connected wirelessly to a network or are networked wirelessly to obtain or share information. The network of these windows (where each window is a node) may communicate via a gateway, or these may also form a mesh where they also communicate with each other. There may be several window network clusters in a building, where each network contains several window clusters or windows which are not a part of any cluster. These clusters may or may not exchange information with each other and, exchange of information will depend how these clusters are organized by the user. Further, these clusters and windows may be optionally integrated with gateways and other building management systems as taught below.

Designs for incorporating power sources, for example solar cells (or photovoltaic systems) and electronics which include batteries, sensors, controllers and wireless communication in the VTWs, are taught. Their incorporation in windows is conducted in a manner so as to preserve the thermal barriers in the VTW frames, and further, electronics, sensors, batteries, and the solar cells, are easy to replace and maintain.

Also taught are the integration of sensors and mechanisms for buildings to respond automatically for energy reduction and also other functions such as privacy, glare reduction, etc. Some of these sensors may be integrated within the windows or be located inside or outside the building, i.e., they are not physically present on the windows. This is important as these windows are not to be limited in their potential by only using those sensory inputs which are physically located within the windows. Also taught are optional integration of these elements in the network along with other sensors, actuators and inputs, user input and preferences, HVAC systems, light, temperature, occupancy sensors, utility grid, weather input, direction of the window relative to the sun, etc. Use of these inputs for automatic energy optimization and user comfort is also included in the teachings.

Since these windows control the transmission of solar energy inside the building by changing the depth of coloration, this, along with the solar energy falling on the window, can be used for a method for calculating the energy being saved.

In another embodiment, wireless EC windows are disclosed, wherein, to save energy, each window or window cluster may self-determine its solar/light transmission and change its optical state accordingly. This mode may be overridden by a user to select a specific optical state (i.e., to change the amount of light transmission) or mode. In some cases, the overriding is done temporarily, meaning that it may last only a short while, until the solar intensity falling on the window changes by a certain amount for example, or it may last for the rest of the day, for several days, or until the user puts it back into a self-regulating mode, which will depend on the control algorithm of the system.

The windows derive electrical power from a local source present in the window for changing the optical state and wireless communication with the user. This power may also be provided by a battery present in the window which can be charged by a local source such as a photovoltaic source located in the window. In one embodiment, the window has its own light sensor and a sensor for measuring the outside ambient temperature, and in another embodiment the solar cell used in the window also functions as both the light and the temperature sensor. In another embodiment any of the inputs such as solar light intensity, outside temperature, and weather are obtained wirelessly from the external sources (such as a sensor located elsewhere in the building, internet, a cloud server or “the cloud”).

In another embodiment, the windows communicate with the user wirelessly through a remote or via a gateway, and in some cases these windows are a part of a network (such as a mesh network) where they also communicate with each other. In most cases the windows require a two-way wireless communication system where they receive signals wirelessly and they wirelessly transmit signals (two-way radio), in some cases the transmitting radio may be turned-off or may be absent to save on power/cost. In the latter case, the windows are able to receive communication (one-way) and act on them and may even display a visual signal to acknowledge the receipt of the signal and subsequent action.

In other embodiments, low-cost EC panels suitable for these windows and their optical and electrical properties are also disclosed. Teaching regarding EC panels which self-bleach (or go to a clear state) in a reasonable time in an emergency situation are included. Teaching is also included on the sizing of the solar cells to the size of the VTWs. Additional benefits of these windows to actively control glare and privacy are also disclosed herein.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings of which:

FIG. 1 shows a schematic of a section of a building window according to this disclosure.

FIG. 2 shows a schematic of a building window according to this disclosure.

FIG. 3 shows schematics of one method of establishing connections for an eWindow (or electronic module) comprising a Power Controller & Modulator (PCM), Master Control Unit (MCU), and battery, with a VTW, a solar panel, and optional sensors and also to a user interface/gateway.

FIG. 4a shows solar intensity on vertical surfaces in various directions on a clear summer day in Denver, CO.

FIG. 4b shows modelled solar intensity on vertical surfaces in various directions on a clear June 15 in Los Angeles, CA.

FIG. 4c shows modelled solar intensity on vertical surfaces in various directions on a clear December 15 in Los Angeles, CA.

FIG. 5 shows solar intensity on vertical surfaces in various directions on an overcast summer day in Denver, CO.

FIG. 6 shows a schematic of an I-V curve for a solar cell.

FIG. 7 shows the impact of solar light intensity of an I-V curve for a solar cell.

FIG. 8 shows the impact of temperature of an I-V curve for a solar cell.

FIG. 9a shows the front view of an EC panel.

FIG. 9b shows an isometric section of the EC panel shown in FIG. 9a.

FIG. 10 shows an insulated glass unit (IGU) with an EC panel that is laminated.

FIG. 11 depicts a network arrangement having one or several windows.

FIG. 12 depicts an extension of the network arrangement of FIG. 11 further connecting to other sensors and building automation systems having one or several windows.

FIG. 13 depicts an alternative network arrangement.

### DETAILED DESCRIPTION

While aspects of the subject matter of the present disclosure may be embodied in a variety of forms, the following description is merely intended to disclose some of these forms as specific examples of the subject matter encompassed by the present disclosure. Accordingly, the subject matter of this disclosure is not intended to be limited to the forms or embodiments so described.

Since energy-efficiency of building envelopes is becoming increasingly important to reduce energy consumption, it is equally important to have energy-efficient windows that separate the exterior and the interior of the building. Variable light transmission windows (VTWs) for buildings for reducing energy consumption in buildings also have other benefits. VTWs may also be used to control the daylight so that during certain times of the day, the building occupant can reduce or eliminate glare from the sun, while under some other conditions these windows also provide privacy (e.g., to replace blinds) in the darkened or in low-light transmitting state.

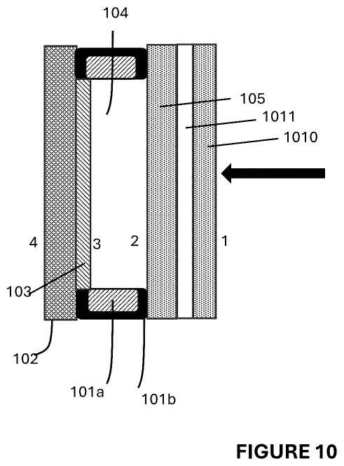

Insulated glass units (IGUs) for VTWs are constructed by using a variable light transmission panel (VLTP) and assembling it with one or two more additional glass panels in a parallel configuration with a gap in between the panels. The gap between the panels is controlled by spacers and sealant located near the perimeter and is filled with a gas such as air, argon, krypton and mixtures thereof. Such IGU assembly provides superior thermal insulation as compared to a single pane glass window. The surfaces in a double pane IGU are labelled starting from the outside. A double-pane IGU with a VLTP as one pane and a glass sheet as a second pane (or transmissive optical element) for energy saving configuration is assembled so that the EC panel faces outside the building, and the second pane faces inside the building. The outside-facing surface of the IGU (or the EC panel in this case) is labelled as surface 1. The EC panel's surface facing the IGU gap is labelled as surface 2. The surface of the glass pane facing the gap is labelled as surface 3. Finally, the surface of the glass pane facing the building interior is labelled as surface 4 (this numbering system is also illustrated in FIG. 10 which is discussed below).

An IGU with a VLTP is then integrated into a window frame to fabricate a window which is then installed. The frame may be made out of wood, plastics (e.g., unplasticized polyvinylchloride (UPVC), fiberglass), metals and also their combinations. The VLTP panel in this disclosure is an electrochromic (EC) panel of which the light transmission is varied by application of electric power. A construction of a typical IGU which uses an EC panel is shown in FIG. 10, and discussed below. These EC panels are either formed on a glass substrate by applying multiple coatings (which include coatings with EC function) or assembling two coated pieces of glass substrates in parallel with an EC medium in between and sealing the perimeter to protect the EC medium.

Frequently, EC panels are further laminated to another polymeric film or to another glass substrate using a polymeric interlayer, such as PVB, to improve safety against breakage and to reduce exposure of the EC panel to ultraviolet radiation. In the IGU assembly, the gap between the EC panel or a laminated EC panel and the second panel is filled with a gas, or the gap is evacuated. The gap between the panels is maintained by a perimeter spacer and it is sealed. Typical gases used in the gap are air, argon, krypton or a mixture of two or more of these. Argon and krypton have a lower thermal conductivity compared to air; thus, they lower the heat transmission or the thermal conductivity through the windows. The highest thermal insulation or lowest thermal conductivity is provided by vacuum. Further, low-e coating is present at least on one of the surfaces of the panel facing the above-mentioned gap and/or on the surface facing the inside of the building.

Typically, to take advantage of the energy savings offered by using windows having an EC panel, the placement of the EC panel within the IGU is such that it faces outside of the building. There may be a third optically transmissive panel which may be located in this gap and may also have at least one of its surfaces coated with a low-e coating. The presence of a third panel creates two gaps one on either side which may be both filled with gas or one or both may be evacuated as discussed above, and these two gaps may or may not be sealed from each other. If the two gaps are not sealed from one another, then gas may be exchanged between the gaps for pressure equalization. The third panel may be thin, e.g., in the range of about 0.3 mm to about 1.6 mm, to reduce the weight of the IGU. If there are multiple low-e coatings within an IGU they may be different from each other in terms of the coating material composition and/or the number and thickness of layers which form the low-e coating. These IGU configurations are extensively discussed in the teachings of published U.S. patent application No. 20240363898A1 which are incorporated herein by reference.

In some VTWs, flexible or polymeric films are used to form an EC element and these EC films are affixed to the interior of the standard windows having an IGU or a non-IGU construction (e.g., single pane window). Since these films are affixed to surface 2 of a single pane window or surface 4 of an IGU, as discussed below, such incorporation is not useful for energy savings. The same would be true if a variable transmission panel is put as an insert towards the interior of a single pane window with a gap in between to form an IGU type structure. If there is no low-e surface located past the EC panel and towards the interior of the building, such windows will reduce the glare in the building interior but they do not save energy. Almost all of the light that is absorbed by the EC panel in the dark state is simply transmitted to the interior of the building as heat. This relates to an important concept of Solar heat Gain Coefficient (SHGC) which is discussed in detail below.

### Optical Properties-VLT, Privacy, SHGC, U Values and Energy Efficiency of VTWs

Visible light transmission (VLT), thermal conductance (U value) and SHGC are all important window parameters for utility, comfort and energy efficiency. Use of VLTP in windows should further enhance the window properties. These properties will be discussed and methods suggested to enhance these properties by using VLTP in self-regulated windows. The solar radiation range is between 0.29 to 2.5 μm (of which 0.29 to 0.4 μm is UV, 0.4 to 0.7 μm is visible and beyond that is Near infra-red or NIR). This solar radiation is attenuated by the EC element in its darkened state by absorption. For example, on a bright summer day when VTWs darken (or reduce optical transmission, or change to a colored state), they become hot by absorbing the impinging solar radiation. As the solar energy absorbed by these elements converts to heat, both this heat and any transmitted light enter into the building. In the IGU construction, where the EC panel is located as the outside panel and has a low-e coating towards the inside following the EC panel, this heat emanating from the EC panel is reflected from the low-e surface to the outside of the building through the window. This reflection (or radiative expulsion) passes through the EC element which does not absorb the long wavelength heat radiation (typically the reflected heat is in a range of 5 to 50 μm). Such low-e coatings may be placed on surfaces 2, 3 or 4 of the IGU. It is to be noted that in this construction surface 2 is the surface of the EC panel facing the IGU gap.

Several measures are used to characterize the solar light transmission through a VTW. Primarily the two optical measures are visible light transmission (VLT) and the Solar Heat Gain Coefficient (SHGC). Typically, VLT is measured by taking the photopic response or the luminous efficacy of a standardized eye at different wavelengths and then weighting it with the amount of the solar radiation passing through in the region of 0.4 to 0.7 μm. VLT is dependent on the wavelength dependent photopic response of the human eye, p(λ), which varies from 0 to 1, and the wavelength dependent transmission of the window, T(λ). VLT is calculated from these parameters according to Equation 1:

$$VLT = [ \sum p ( λ ) * T ( λ ) ] / \sum p ( λ ) \qquad ( Equation 1 )$$

In the literature, the photopic response is found in a published table as a function of wavelength (for example see Schwiegerling, 2004). Sometimes another measure is used for VLT, and that is simply taking the transmission at 550 nm, where 550 nm is close to the peak of the eye photopic response. These two numbers are close to one another for devices that are color neutral or color to a green color, and may be slightly different for the blue coloring VLTPs or windows (VTWs). Transmission may be measured at 550 nm or VLT may be used. Therefore, either VLT or 550 nm transmission may be used interchangeably for visible transmission. As an example, if the percentage transmission at 550 nm or the VLT of the EC element, or of the IGU having an EC element changes from 60% to 20%, then the reduction ratio at 550 nm or the contrast at 550 nm is 3 (calculated as 60/20=3). In one measure, to provide visual contrast, the optical transmission (measured at 550 nm or VLT) of either the EC element alone or, when incorporated in a IGU, is reduced by at least a ratio of 3. This reduction is measured when comparing the EC element's or the IGU's most transparent (clear) state with the most darkened (dark) state. In another embodiment, this reduction ratio is 5 or more, and in another embodiment greater than 10 or more. Generally, for building windows this ratio may be as high as 1,000.

Radiated solar energy transmission through a window is measured using a parameter called Solar Heat Gain Coefficient (SHGC). This is a dimensionless number between 0 and 1, where 0 means that none of the solar radiation is getting through, but then this value also means that the window is completely dark and there is no visibility through it (in UV, visible or NIR). A window with a value of 1 means that all of the solar radiation is coming inside the building through a window. It is to be noted that a standard window will have a fixed SHGC. A VTW on the other hand will have several SHGC values which depend on its optical state (or the level of darkening)—this is because with increasing darkening more solar light (or radiation) is absorbed which heats up the EC element in the VTW proportionately and this heat is rejected outside the building from a low-e coating as discussed above. Sometimes the SHGC ratio in the clearest state of the IGU (EC panel in clear state) to the darkest state when the EC panel in the dark state is used to specify the VTW. A desirable range of the SHGC ratio in one embodiment is between 1.5 to 10, and in another embodiment between 2 and 6. For the VLTP (or EC) inserts and the adhesively bonded EC films affixed to the interior facing panels in an IGU, the heat is not rejected outside and enters into the building, the SHGC differences between the darkened and the bleached states is quite small, if any. LSG (light to solar gain) is the ratio of VLT to SHGC. This helps in comparing different windows or VTWs in different optical states where the visible transmission may be reduced or increased more relative to all of the solar radiation that is UV, visible and NIR radiation combined.

Another important parameter for the window efficiency is its U or R value, which are mathematically related by U=1/R. U value of a window is thermal conductance, and R is thermal resistance. U value (or U factor) is typically expressed in the United States using Imperial units which are BTU/(hour-ft²-° F.). The SI units are W/(m²-K), where U value in imperial units can be converted to SI units by multiplying by 5.67 (e.g., 0.21 BTU/(hour-ft²-° F.)×5.67=1.19 W/(m²-K). Unless mentioned otherwise the U and R values used in this document are in Imperial units. For a window in all climates, low thermal conductivity (i.e., lower U value or higher R value) is preferred so that the heat conductance from outside to inside or vice versa is as low as possible. However, U value, SHGC and VLT are not completely independent of each other, so techniques used to change one impacts others. Hence in traditional windows with static optical transmission, most optimum values are sought for a given climatic zone as will be discussed later in Table 2.

Table 1 provides generic values for various types of standard windows (or windows with static optical transmission) and a comparison is made for a window with single pane and the IGUs with double panes. Going from a single glass pane window to an IGU with a dual pane results in a large drop in U value. When a low-e coating (generic, single layer silver) is introduced on one of the surfaces of the glass facing the gap there is a further drop in the U value with only a modest change in VLT and SHGC, further use of argon (usually 90% argon mixed with 10% air) results in a further drop of U value. For triple pane IGUs, where there are two gaps in the IGU (between the first and the second pane and then between the second and the third pane) will reduce the U values by almost 15 to 40% of the double pane window values as shown in Table 1.

TABLE 1
Comparison of various window performance factors for a
single pane window to various generic double pane IGUs

| | Glass | | | | | | |
|---|---|---|---|---|---|---|---|
| Glass | thickness | | | | | U | |
| system | (each pane) | Low-e* | Gap/fill | VLT | SHGC | value | LSG |
| Single clear | 6 mm | No | None | 91% | 0.88 | 1.02 | 1.03 |
| IGU, two | 6 mm | No | 12.5 mm/air | 79% | 0.7 | 0.5 | 1.13 |
| clear glasses | | | | | | | |
| IGU, two | 6 mm | Yes | 12.5 mm/air | 74% | 0.62 | 0.35 | 1.19 |
| clear glasses | | | | | | | |
| IGU, two | 6 mm | Yes | 12.5 mm/Ar | 74% | 0.62 | 0.33 | 1.19 |
| clear glasses | | | | | | | |
| IGU, three | 6 mm | No | 2x(12.5 mm/Ar) | 72% | 0.64 | 0.32 | 1.12 |
| clear glasses | | | | | | | |
| IGU, three | 6 mm | Yes | 2x(12.5 mm/Ar) | 69% | 0.56 | 0.19 | 1.23 |
| clear glasses | | | | | | | |

*Low-e coating located on surface 3, or on the inside glass with the low-e coating facing the gap

The US Department of Energy (DoE) in working along with National Fenestration Research Council (NFRC) have been promoting and requiring increasingly energy efficient window products over the last 50 years. This means that for windows they routinely issue guidelines where both the U values are lowered, and narrower ranges of SHGC values are mandated or prescribed for new building windows or for retrofits. The latest guidelines for residential building windows with increased energy efficiency are called Energy Star 7.0. They recommend windows with different U and SHGC values for different climatic regions in the United States. They have divided the US into four climatic zones and recommend the following as shown in Table 2. An interesting theme emerges from this data. The performance factors of windows in the Northern region are tuned to provide better energy efficiency in cold weather, particularly by having a lower “U” or thermal conductivity value, whereas in southern region the factors are tuned so that more energy is saved during summer by lowering the SHGC requirements. For example, in the Northern regions more emphasis is put on the lowering of the U value so that not too much of the heat from inside the house is conducted outside (or lost) through the windows during the winter. In these regions, there is no upper bound to the SHGC values as higher values are desirable so that more solar light (visible or NIR) can infiltrate through the windows to heat the building to reduce HVAC heating requirements. In southern climates SHGC values are capped because too much solar energy may come in and heat the building and the excessive heat will have to be removed by expending energy via air-conditioning.

TABLE 2
Energy Star 7 Guidelines

| Climate Zone | U-Factor | SHGC | |
|---|---|---|---|
| Northern | ≤0.22 | ≥0.17 | |
| | 0.23 | ≥0.35 | Prescriptive |
| | 0.24 | | |
| | 0.25 | ≥0.40 | |
| | 0.26 | | |
| North-Central | ≤0.25 | ≤0.40 | |
| South-Central | ≤0.28 | ≤0.23 | |
| Southern | ≤0.32 | ≤0.23 | |

The most effective way to reduce the U value and meet the SHGC requirements beyond what is listed in Table 1 is by using multiple low-e coatings. In one embodiment, low-e coatings are used on one of the surfaces facing inside the gap of the IGU (surfaces 2 or 3 of the IGU—for example see FIG. 10 for the surface nomenclature). Typically these low-e coatings have one or more silver layers separated by dielectric layers. In addition, on surface 4 low-e coatings are introduced on the surface that faces inside the building. The types of low-e coating compositions facing inside the building have to be durable to scratches, resistant to corrosion and discoloration, and easy to clean with commercially available liquid cleaners. In general, low-e coatings having a layer of silver metal (or silver alloy) are not suitable due to these reasons for use on the fourth surface. The low-e coatings for the fourth surface contain conductive metal oxides such as indium-tin oxide (deposited by sputtering) or fluorine doped tin oxide (deposited by pyrolytic processes). These are available from several companies, such as Cardinal glass (Eden Prairie, MN) as i89; and available as TEC™ glass from Nippon Sheet Glass (Toledo, OH). In general, the emissivity of the silver containing low-e coatings ranges from about 0.01 to 0.05 and the emissivity of the interior facing window surfaces (4th surface) ranges from about 0.08 to 0.3. As a comparison, the surface of uncoated glass has an emissivity of about 0.9. In one specific embodiment, both surface 3 and surface 4 are coated, where surface 3 has silver containing layer and surface 4 is coated with conductive metal oxide. To make such coated substrates the conductive metal oxide is deposited first and the silver containing coating is deposited on the other side by turning the glass substrate over. Since the metal oxide coatings are harder, they could be carried by the rollers into the coater without scratching. In another method, both coatings are deposited simultaneously by sputtering different compositions on both sides of the glass substrate. The teachings of the published U.S. patent application No. 20240361661 regarding IGUs with such coatings, are incorporated herein by reference.

Another way to decrease the U value (or increase the “R” value) is to use a triple pane configuration in an IGU construction. For VTWs the outer pane is a VLTP along with two other panes. All of the three panes are assembled in a parallel configuration separated by a gap between them that is filled with a gas, and at least one of these panes has a low-e coating. Another way to decrease the U value is by use of vacuum-insulated glazing. These IGU concepts are discussed in the published U.S. patent applications Ser. No. 20/240,363898 and 20240361661, the disclosures of which are incorporated herein by reference.

As an example, Cardinal Glass Industries (Eden Prairie, MN) has introduced low-e coated glass products to be used as one of the panes in an IGU, such as LoE-180, LoE²-272, LoE³-366 and recently LoE-452+. Each of these have single, double, triple and quad layers of silver to increase the low-e efficiency by decreasing the U and the SHGC value, but this also decreases the visible light transmission (VLT) of these panes from 80 to 72 to 66 and to 52% respectively. Further, for glass panels with indoor facing low-e coating, a product called i89 has been introduced by Cardinal Glass which has an indium-tin oxide coating. To achieve the numbers listed in Table 2, that is to lower U value with increasing number of silver layers, a sacrifice is made in the visible light transmission while also lowering SHGC. Lowering the SHGC down to 0.17 for Northern climates leads to windows which are quite dark all year around, and it is one of the reasons that in the Northern climates there are other combinations of U and higher SHGC prescribed. Using static windows with low SHGC will cause diminished energy gains by solar heating in winter. In northern climates, more weightage is given to a lower U value glass for a standard window for saving energy as the winters are long and the daylight is limited to a low number of hours. However, to obtain that low value of U, SHGC requirements are lowered to being greater than or equal to 0.17. In these climates a high value of SHGC for standard windows would be very beneficial in lowering the heat energy requirements on a bright winter day, but for overall energy savings throughout the winter days electing a window with lower U value is more beneficial. Since the VTWs offer variable SHGC, there are situations in all of the climatic zones during certain times of the day and in different seasons, where SHGC can be varied to decrease overall building energy use, and/or reduce glare and maximize comfort.

Therefore, use of VTWs which also result in variable SHGC and optical transmission are highly desirable for energy efficiency, glare reduction and comfort during the day and also with changing seasons. In addition, when the sun is low in horizon and the window directly faces the sun, a glare situation may be created and using a VTW the transmission may be adjusted, lowering VLT temporarily. As used herein, the term “window” may be used to describe the windows having the features described herein. In some aspects, a window according to the present disclosure comprises a VTW. In some aspects, a window (VTW) according to the present disclosure comprises an IGU with a VLTP, Sensors, and electronics. eWindows will also be used as a reference for networked windows. In some aspects, a window according to the present disclosure refers to the VTW without the eWindow electronics attached thereto or integrated therewith.

In one embodiment, the EC panels of this disclosure can be used to fabricate IGU units which have a SHGC higher than the prescribed limit of the Energy Star 7 (compared to a fixed SHGC window) and modulates the SHGC to a value lower than this fixed value. This increases the energy efficiency as compared to a window with a fixed SHGC. As an example, for southern zone where the suggested number for SHGC from Table 2 is ≤0.23, one can provide an EC panel in the IGU so that the SHGC can be varied by a factor of 2 to 5 from its clear to the dark state encompassing the value of 0.23. As an example, if the SHGC of a VTW varies by a factor of 2, e.g., from 0.3 to 0.15 then higher SHGC selection as compared to a window with a fixed SHGC of 0.23 will contribute to more solar heating of the building when it is cold outside and when the lower SHGC is selected for summer, it would reduce the cooling requirements as solar energy entering the building is reduced.

Generally, a typical range of variation of SHGC for existingVTWs from its clearest to the darkest state range is from about 1.8 to 5, depending on the type of materials and technology used to fabricate the EC elements. It is important to note that when EC panels or VTW darkens or clears there is only a little impact, if any on the U value, but there is a large change in SHGC and/or VLT. Thus, windows for each climate are fabricated by a judicious choice of the number of panels in the IGU (e.g., two or three) and type and placement of the Low-e coatings and the type of gas used to fill the gap(s). Having VTW opens the possibility of increasing the window efficiency by modulating the solar radiation that is being transmitted through them. Using VTWs also provides another possibility that a single window could meet requirements for multiple US zones or all of the US zones while providing the benefits of variable VLT and SHGC. For example, a VTW having a variable SHGC from ≥0.4 and less than ≤0.23 with a U value of 0.22 will meet the requirements for all climatic zones in US (see Table 2). This greatly standardizes the manufacturing methods. In addition, VTWs also provide other benefits of glare control and privacy.

Solar Heat Gain Coefficient (SHGC) measures the amount of solar energy that is transmitted into the building. Table 3 has been taken from the published specifications of IGUs used in commercial VTWs from Sage Glass (mkt043_performance_and_acoustical_data_flyer.pdf) (sageglass.com). Sage Glass EC panels have EC coatings containing oxides of tungsten and nickel. This table shows four different IGU configurations using similar EC panels and different kinds of low-e coatings and their placements. VLT refers to the visible light transmission, which changes for these panels from 57% or higher in the clear state, down to 1% in the darkened state.

TABLE 3

| | | | |
|---|---|---|---|
| Level of tint | VLT, % | SHGC | U value (Btu/(hr-ft²-° F.)) |

IGU: SageGlass Clear with SR2.0

| | | | |
|---|---|---|---|
| Clear | 60 | 0.41 | 0.29 |
| Light tint | 18 | 0.16 | 0.29 |
| Medium Tint | 6 | 0.11 | 0.29 |
| Full tint | 1 | 0.09 | 0.29 |

IGU: SageGlass Clear with Bright Silver

| | | | |
|---|---|---|---|
| Clear | 57 | 0.41 | 0.25 |
| Light tint | 20 | 0.16 | 0.25 |
| Medium Tint | 5 | 0.10 | 0.25 |
| Full tint | 1 | 0.09 | 0.25 |

IGU: SageGlass Clear with SR2.0 and Low-e 180

| | | | |
|---|---|---|---|
| Clear | 58 | 0.40 | 0.25 |
| Light tint | 17 | 0.14 | 0.25 |
| Medium Tint | 5 | 0.09 | 0.25 |
| Full tint | 1 | 0.07 | 0.25 |

IGU: SageGlass Clear with SR2.0 Skylight with inboard laminate

| | | | |
|---|---|---|---|
| Clear | 58 | 0.41 | 0.27 |
| Light tint | 17 | 0.15 | 0.27 |
| Medium Tint | 5 | 0.10 | 0.27 |
| Full tint | 1 | 0.09 | 0.27 |

Table 3 shows that most of the decrease in SHGC is achieved by the time the windows reach a tint level of about 5-10% visible transmission (VLT). It is not necessary to color the windows deeper to extract any further meaningful energy efficiency. One of the reasons to darken deeper is to avoid direct glare or to obtain better privacy under certain conditions of reduced outdoor lighting as compared to the indoors. For glare reduction in the morning for an east facing window or a west facing window in the afternoon, a deeper coloration is required. This will depend on the intensity of the glare and the window darkened appropriately. It has been found that in acute glare, 2% transmission or lower is required if the user is working close to the window. However, glare situations do not last long due to the sun movement and they are only important when the user is in the vicinity of the window. Since the sun, during the winter (in northern hemisphere), changes its course to a more southerly direction and is lower on the horizon, even the southeast, south and southwest facing windows could cause glare discomfort only when the user is close to a window. As would be discussed later, in self-regulating windows it is important to provide a user override for certain periods of time,

In some cases, the variable transmission EC element is fabricated as a flexible film that is adhesively bonded to the window (or the IGU) surface which faces the building interior. In some other cases, an EC element is formed on glass that is used as an insert in an existing window which is placed from the inside. Such films or interior inserts are not helpful in saving energy on warm bright days, they only serve as an interior electronic blind. This is because when these EC elements absorb the solar energy they simply transmit that as heat in the building interior, thus they do not impact SHGC when they change from clear to darkened state. This type of integration is not preferred in the windows and IGUs of this disclosure.

For privacy, the situation differs between nighttime and daytime, and it is dependent on the difference in light intensity, between the areas separated by the window as well as the visible light transmission and the reflection characteristics of the window. The privacy issue has been discussed in detail in published US patent application US20230066465A1, the teachings of which are incorporated herein by reference in their entirety. US20230066465A1 discloses methods and materials to obtain privacy using a VTW which partitions the indoor and the outdoor space, wherein the indoor space has an illumination level of L₁ in lux and the outdoor space has an illumination level of L₂ in lux. R is visible reflectivity in percentage of the VTW from the outside and T is visible light transmission in percentage of the VTW. Privacy of the indoor space through the VLTP from the outdoor space is controlled by adjusting the visible transmission of the VTW. Privacy is achieved when the value of P≥5 is reached according to Equation 2. It is to be noted, that these light intensities for privacy on the exterior side are measured in a close proximity to the door/window that has a VLTP. For example, just as one steps outside the door/window. The interior light intensity may be also measured by placing a light sensor in close proximity to the door/window, but its field of view may be small (e.g., two to fifteen degrees) to capture light from a connected hallway or another room that opens up facing this door/window. The indoor sensor placement and type is particularly important when the interior lights are on and it is dark outside.

$$P = ( R \times {L}_{2} ) / ( T \times {L}_{1} ) , \qquad ( Equation 2 )$$

During the daytime (not in the early morning or at dusk), the typical light intensity outside on a bright day is in the range of 10,000 to 100,000 lux. Indoor intensity in most cases is less than about 500 lux, unless specific areas are lit by direct sunlight or there are bright task lights. Thus, for privacy calculations during the day, if interior light intensity is not measured a lux value of 500 lux may be assumed. When the VTW colors, the change in transmission is large and usually change in reflectivity is small. Assuming a reasonable reflectivity of 10% from the window in both states, it can be seen that even at highest transmission of about 70% during the daytime at peak sunlight intensity, P is 29, which exceeds the value of 5 showing that even in the clear state, a daytime privacy is maintained for a window that partitions bright sunlight and indoors. As the outside intensity decreases, a decrease in T (window transmission) will maintain P≥5. At nighttime even a coloration down to 0.1% may not result in privacy due to bright indoor lighting and the outside being pitch dark. Privacy during the daytime and nighttime may be achieved by a combination of reasonable darkening from 2 to 10%, suitable reflective properties of the window and having an outside illumination. Therefore, a practical way of attaining privacy at nighttime is to not only decrease the optical transmission of the VTW but turn on a light outside and in the vicinity of the window with sufficient brightness so that P≥5 is maintained. Privacy may also be triggered when someone approaches a building, for example a service to deliver packages or for maintenance around the building. An exterior motion sensor or an alert from the delivery truck may be utilized for this.

Table 3 also shows that the U value is largely unchanged in different optical states of the VTW. Therefore, VTWs primarily enhance energy efficiency by changing the SHGC. The integration of power sources such as solar cells to make self-regulating VTWs enhances their energy performance and is done cost-effectively.

### Windows, Insulated Glass Units (IGUs) and Placement of Solar Cells, VLTP and Electronics

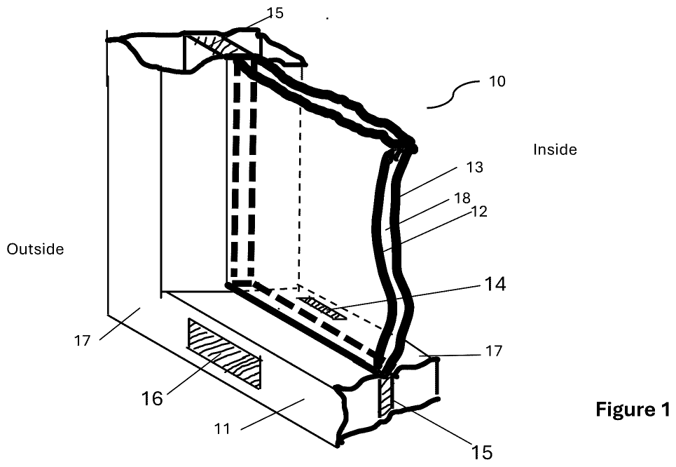

FIG. 1 shows schematics of a cut-out of a building window 10 which comprises a frame 17, and a two panel IGU formed using panels 13 and 12 with a gap in between shown as 18. The IGU gap may be filled with a gas, such as argon, krypton, air, mixtures of gases selected from these or even evacuated. If evacuated, there are supports (e.g., pillars or balls of steel or some other material located throughout the IGU so that it does not collapse due to external air pressure (these pillars are not shown). The gas filled gap is typically from about 2 mm to 20 mm in most IGUs, where 4 mm to 13 mm is more common, and when it is evacuated this gap may be between 0.5 mm to about 3 mm. When vacuum is created between two pieces of glass and sealed, that is called vacuum insulated glazing (VIG). A combination of VIG and VLTP results in the most energy efficient glass with low U values, such as 0.17 to 0.08 BTU/(hour-ft²-° F.) and also one where SHGC can be varied actively.

In one embodiment, a VIG glass formed using two panels may be combined with a gap with a VLTP where the gap is filled with the gas. The Low-e coating may be placed on any of the surfaces facing the gap or within the VIG element. In FIG. 1, the perimeter sealant and spacers that separate the two glass or optically transmissive panels forming the IGU are not shown. The orientation of the window facing outside and inside the building is indicated in FIG. 1.

Typically, panel 12 has variable light transmission properties (such as an electrochromic [EC] element), and the other panel 13 is an optically transmissive glass. The EC panel itself may be composed of multiple optically transmissive panels (such as glass) which are coated and combined in parallel configuration by lamination using polymeric films and electrolytic materials. At least one of the surfaces of one of these panels (12 or 13) facing the gap or the surface facing inside the building is coated with a coating or a stack of coatings providing low-emissivity (Low-e) properties. The window frame 17 may be made out of extruded polymeric channels (such as unplasticized PVC) or made of metal channels with or without an overlay of wood or plastics (this overlay is not shown). These channels are generally hollow to provide good thermal insulation and structural integrity at a lower weight. When metals are used in the frames, typically they are separated by a thermal break 15 from the inside facing metal to the outside facing metal, which is generally a polymeric foam or felt to which the metal window frame is attached to on both sides. This is done for reducing the heat transfer by either conduction or convection, from inside to outside and vice-versa, i.e., thermally insulating the metal inside to that on the outside of the frame.

The frame shows a solar cell 16 that is attached to the frame and facing the outside of the building. In the inside of the window frame a detachable cover 14 is shown, which is cover to access an electronics module (along with a rechargeable battery, discussed later) is located within the frame (not shown). This electronics module is electrically connected to the solar cell through wiring within the frame. Since this wiring will cross the thermal break 15 in the window, all precautions must be taken to preserve this thermal barrier. There may be several methods to achieve this. In one, the hole size in the thermal break is minimized (e.g., 2-5 mm diameter or equivalent) and around the wires an insulating rubber/foam plug is placed which is compressible and forms a seal between the frame and the wire so that the disruption to this thermal break or any air flow is further reduced or eliminated. It is important to thermally isolate the electronics when located in the frame, accessible from the inside to the solar cell which is located outside, while they are electrically connected. The exterior facing solar cell is the primary source of power for the electronics and charging the aforementioned battery. Since the electronics module and the battery are located on the inside of the window frame past the thermal barrier, the temperature experienced by these elements is closer to the room temperature and is protected from the exterior temperature. It should be noted that in this construction, light falling on the solar cell is not obstructed or masked by the EC panel.

When cover 14 is detached, the electronics, along with a rechargeable battery, may be detached and removed for replacement/maintenance. This also means that the electronics (controller) easily detach from the solar cell array 16 through quick disconnects while keeping the thermal break intact. In one embodiment, even the solar cell array may be removed for maintenance/replacement without removing the electronics or disturbing the thermal break. This cover 14 may also be optionally covered with a solar panel array or may be connected to an optional solar panel array located on the inside facing part of the frame that is either horizontal or located on the vertical part of the frame (not shown, akin to the outside solar cell 16 which is facing outside). This solar panel may also be easily detachable from the electronics or the window frame. The solar cell array on the inside is a secondary power source to provide power to the electronics and/or charge the battery. It is important that the repair costs for these windows is low, and that all of these components along with any sensors, LEDs or modules located in these windows is easily removable/repairable/replaceable/upgradable without having to remove the VTW or the IGU in it from its installed location. In one embodiment, the firmware and software are also upgradable wirelessly.

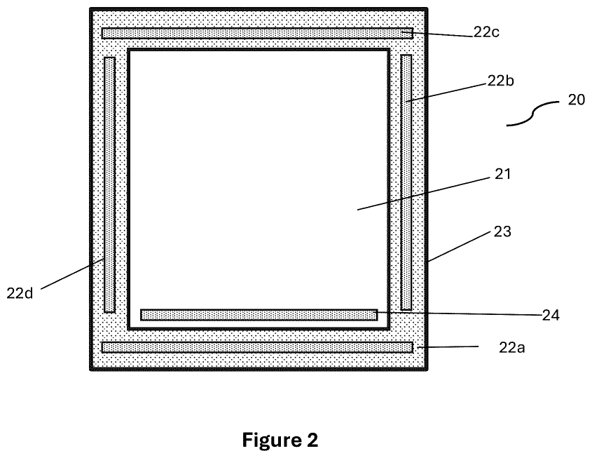

FIG. 2 shows a frontal view of a window 20 as one looks from the outside of a building. The power producing solar cells may be located almost from one edge of the frame to the other, as shown in FIG. 2, or only in part of the frame. These solar cells may be a sequence of cells attached together to form an array.). It is to be noted that the term “solar cell” or “solar cell array” in this disclosure often refer to more than one solar cell unit, which are connected together and then connected to the electronics, or connected separately to the electronics, and may be located at different locations on the window. The window frame is shown as 23 and the visible transmissive area (or daylight area) of the IGU is shown as 21. The perimeter sealant, etc. of the IGU is masked by window frame 23.

FIG. 2 shows many options of locating the solar cells in the window. For example, in one embodiment, the solar cells 24 are located on the surface of either of the two panels forming the IGU, where this surface is facing the outside or the gap between the two panels (see gap 18 in FIG. 1). In this construction electrical leads from the solar cell are pulled through spacer/sealant at the perimeter that forms the IGU. In another embodiment, these may be bonded to the outer surface of the substrate facing outside (i.e., surface of panel 12 facing outside as shown in FIG. 1, the solar cell is not shown). When the solar cells are located on the IGU, the view through the window is obstructed and may not be preferred in certain situations. When the solar cells are placed within the IGU that is in the gap or behind the EC panel (which is the outside facing panel, see 12 in FIG. 1), then it will limit the light being received by the solar cell and reduce the electrical power generated. In another embodiment, a light sensor is placed within the IGU gap, which provides input on the extent of darkening of the VLTP when powered as compared to the brightness of the solar intensity outside. This darkening could be directly correlated with SHGC, and also help with the optical diagnostics of the EC panel if there is a change in its optical density with aging.

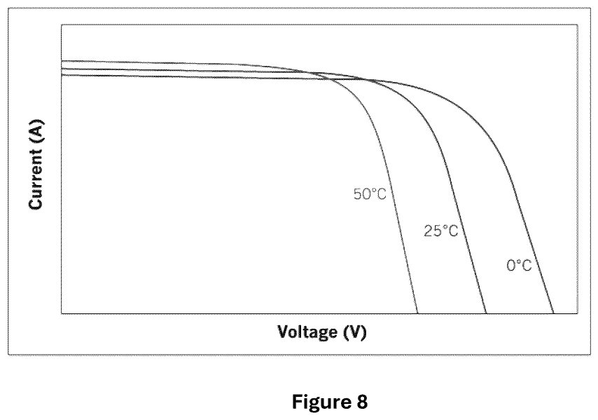

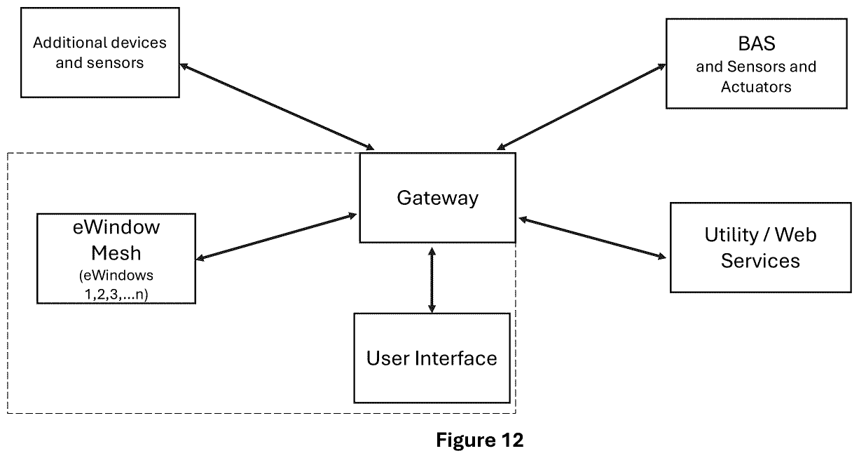

Another way of integrating the solar cell within the IGU is to form an integrated panel comprising both the solar cells laminated to the entire area of the EC panel. This type of solar cells is visibly transparent. In one method, these solar cells are made by using materials that only harvest the UV light and allow the rest of the solar radiation to pass through. This also offers UV protection to the EC panel. In another method, integration of small (conventional) solar cells are placed on a grid. Since the area occupied by these small solar cells is small as compared to the entire window area there is only a small loss in visibility through the window. PCT patent application WO 2022/093985 shows in FIG. 12C a whole laundry list of features that may be integrated with windows having solar cells including electrochromic windows and temperature sensors. They do not teach how these features would interact and provide increased energy generation and energy savings using EC panels and self regulation. As an enablement of their invention they refer to FIG. 8c showing an IGU where the photovoltaic panel is located on the surface of the interior panel of the IGU that faces the gap. They do not show or teach the location of the EC panel. Since there are only two panels in the IGU of this reference, the EC panel is likely to be the one being the outer IGU panel. If this is done, then that will choke the solar cell when the EC panel colors as it will deprive the light that the solar cell needs for generating power. Arguably, if the EC panel is located as the interior panel of the IGU and somehow integrated with the solar panel, then that would not result in reduction of energy consumption or change in SHGC as all of the absorbed solar light will be passed indoors as heat and the purpose of the solar cell will be defeated because the energy that it produces goes simply in coloring the EC panel which causes an increase in energy consumption of the building. It must be noted that either in this configuration or the ones described above the solar cell should not be masked by the EC or the VLTP element.

In another embodiment, the power producing solar cells are located on the frame as shown by 22a, 22b, 22c and 22d of FIG. 2. These panels may be edge-to-edge or only in a certain part of the frame (as was shown by 16 in FIG. 1). In one embodiment, the solar cells are only present in one part of the frame, in another embodiment they may be present on all four sides of the frame or only three sides such as 22a, 22b and 22d, or on two sides, etc. In one embodiment, these cells are electrically connected to each other in the frame and then attached to the electronics discussed above by a common connector while in another embodiment these solar cells are connected to the electronics separately. Similarly, when the solar cells are located in the windows which face inside the building, they may also be located in multiple positions. An advantage of having solar cells in multiple positions is the ability to get good light exposure for at least one of the solar cells depending on the sun direction, in case one or more are masked by a plant, tree, another building, furniture, overhangs, etc.

In one embodiment, it is desirable that the window frames (or the surfaces of the frames that have solar cells) are dark in color (gray, brown, blue, black, and different combinations, etc.). This is because the solar cells are dark in color as they absorb light, thus their integration in the frame with dark colors will not make them stand out. The darkness of the frame may be measured by measuring their color in reflectance on a L*a*b* scale which has been standardized by the International Commission on Illumination (abbreviated as CIE) in 1976. On this scale typically, L* measures the darkness and a* and b* determine the color. L* can have a value from 0 to 100. A value of 100 is white with no color and a value of 0 is black. A dark colored frame will typically have an L* value of less than about 5 in one embodiment and less than 1 in another embodiment.

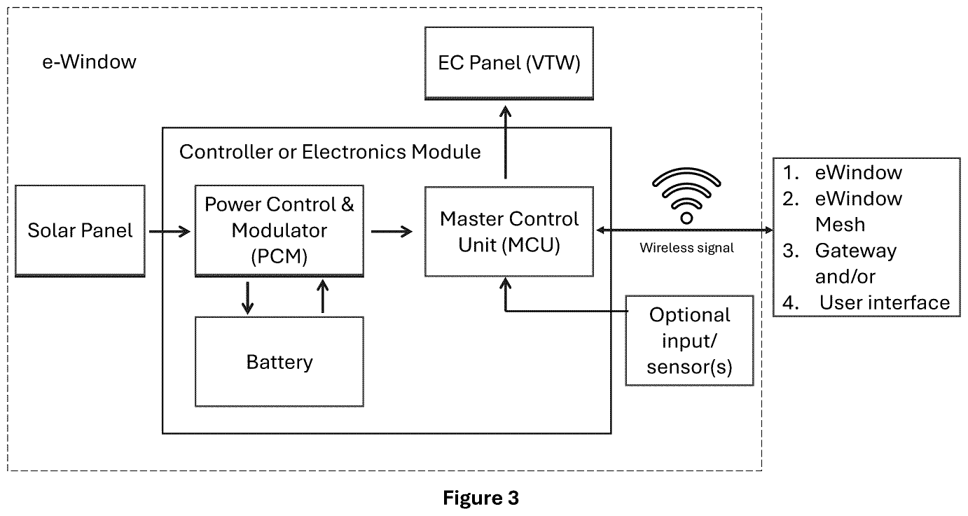

FIG. 3 shows salient features of the schematics of the electronics which are placed in the window frame and its connectivity to the solar cell for all power requirements, the powering of EC panel of the VTW, and recharging of the battery. This also shows that it may be connected to other sensors and it has wireless connectivity. This will be discussed in more detail below in various sections. As discussed later in one of the embodiments of a self-regulating window, there is no requirement to use battery power for powering the VTW, hence it is not necessary to have a rechargeable battery in the system. Some embodiments where a rechargeable battery is not used to power the VTW may still require that a smaller battery be present on board for a clock, and other features. In some embodiments, a rechargeable battery is used. As shown an e-Window comprises of the window having a framed IGU with the VLTP along with the controller, power source and optional sensors. Such windows are connected wirelessly to at least one of, other such windows, another mesh of such networked windows, user or a gateway.

As explained below in the section “Variable Transmission Panel (or EC panel) and its integration VTW”, depending on the properties of a low-cost EC panel suggested for this application, the power consumption based on per square meter of the active area of the EC panel is between 0.2 to 4.8 W/m². The power for wireless communication (“see section on “Centralized networks, energy saving estimates and sizing of solar cells and batteries” is estimated between 0.02 to 0.2 W/m² and for indicators if used is 0.1 W/m². These power budgets for the EC panels include power consumed by the EC cell and associated electronics, temperature sensor and other sensors if present on the window. Therefore, power consumption for each square meter of window (or door) active area has been determined by adding these to be in a range of about 0.3 to 5.1 W/m² of the window area.

Solar Cells: Solar Cell Size Requirements and their Use as Sensors

Since in a preferred embodiment the solar cells are to be integrated with the frames, it is important to determine their size (or surface area) that would be required to generate enough energy to power the VTWs (i.e., the EC element in these windows), for charging of the battery located in the window frame and for a wireless communication system if required in that embodiment. Second, it would be desirable to see if the solar cells could also be used as a sensor to measure solar intensity and/or the outside (ambient) temperature. These inputs would be useful for controlling the optical transmission through the windows and to control the solar energy entering inside the building.

There are many kinds of solar cells with different efficiencies and characteristics. To be able to compare their relative ability to generate electric power a term such as Pₘₐₓ or peak-watt is used for a solar cell or a solar module. This is typically measured by keeping the solar cell (or the solar module) at 25° C. and determining the power produced by subjecting it to solar radiation (or simulated solar radiation). The cell or module faces the simulated solar radiation source (normal to it) with an intensity of 1000 W/m² with energy/wavelength distribution similar to air-mass (AM) 1.5. These conditions are called standard test conditions (STC). This intensity is on the surface of the solar cell. Since solar cells/module come in different sizes, for our purpose we have to normalize Pₘₐₓ to the area of the solar cell or module, e.g. Pₘₐₓ/m². The discussion below is to estimate how much light (solar energy) would fall on the solar cells when incorporated in window frames (vertical orientation to the ground) that face different directions. It is important to emphasize that these solar cells are on the exterior surface of the window or the window envelope. Even if the solar intensity and the temperature in a given geographic area is the same as STC, the power generated by the solar cells placed on a vertical surface will be less that Pₘₐₓ/m², as its solar radiation exposure in that orientation is lower, which is discussed below.

As shown in FIGS. 1 and 2, for most windows, the orientation is vertical (unless there are sloping windows or used as skylights) or the solar cells are placed at an angle from the vertical to increase light harvesting. This application of solar cells is very different from the solar cells used to generate power where they are typically tilted towards the southern direction or follow the sun to generate maximum power. Since the amount of solar energy falling in a particular area (and the angle of the sun) is dependent on its latitude, average numbers will be used for the United States by taking a central location, which in this case was selected as Denver, CO. Although these calculations may be repeated for any region in the US, it is not necessary if conservative assumptions are made for the sizing of the solar cells. As discussed below, solar intensity is also modelled on a clear day for the Los Angeles area, the latitude of which is in the sunbelt region of the US.

Depending on the type of solar cell used (single crystal silicon, multi-crystal silicon, amorphous silicon, CdSe, CdS and pervoskites, etc.), their efficiencies are different and hence for a solar cell of the same area the Pₘₐₓ can be quite different. Solar cell efficiency may also decline with time, and hence the cells may be oversized by 10 to 20% so that the performance of the VTWs have a long service life. For our purposes, we would normalize the Pₘₐₓ to the solar cell area. For example, Pₘₐₓ/m² for solar cells will vary from about 150 to 500 W/m², where most commercial cells used for buildings fall in the range of 150 to 300 W/m². These measurements are made under STC.

When the solar cells are integrated in the window frames, then these windows may be placed facing any direction and with changes from morning to evening as the sun direction changes, and this change is also accompanied by the time of the year and is also dependent on if it is a clear or an overcast day. Therefore, to size the solar cells on a window, Pₘₐₓ cannot be used as a good measure, but this number has to be coupled with the estimated solar light intensity falling on windows which face different directions and also factor in the seasons and weather.

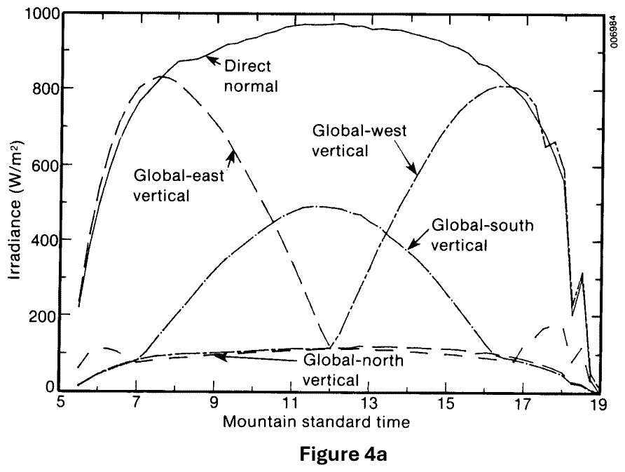

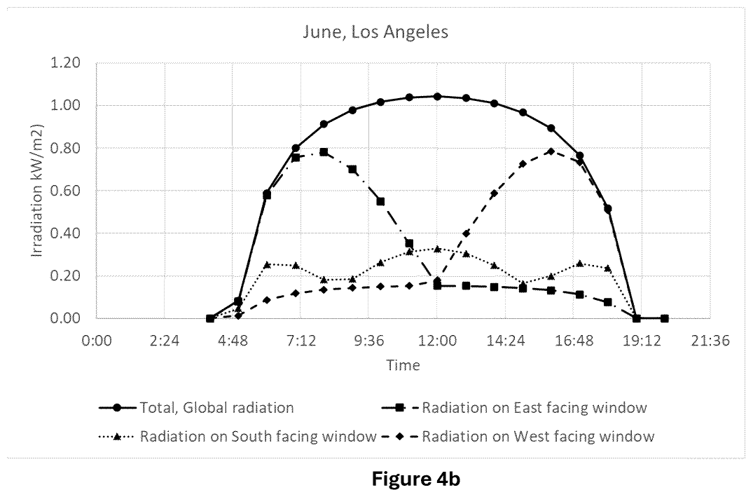

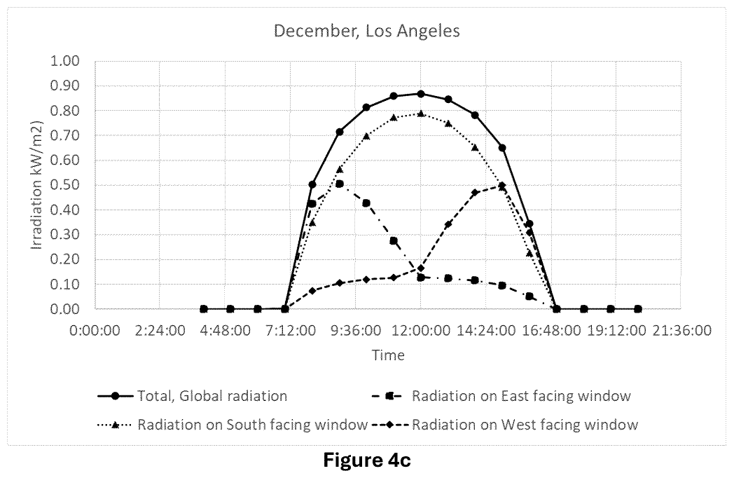

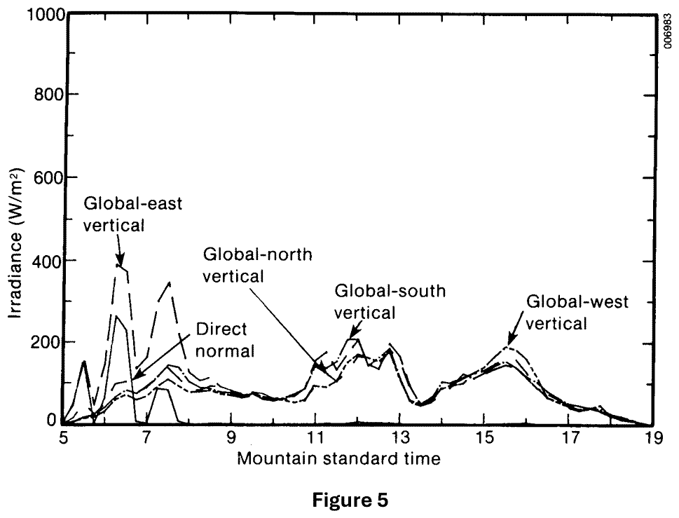

To get a handle on the above issue, we would like to draw attention to the published values (From Maxwell, et al, 1986) of solar intensity (in W/m²) on vertical surfaces. FIGS. 4 and 5 show these intensities on a clear day (Aug. 10, 1984) and on an overcast sky (Aug. 6, 1984) respectively in the Denver (CO) region, which is at about a central latitude in US. The data are for four directions, that is the light sensor facing north, east, south and west. In addition, this is compared to the direct normal solar intensity (that is intensity on the light sensor as it directly faces the sun and tracks it all throughout the day). These intensities are averaged over 15-minute time intervals.

FIG. 4a for a clear summer day shows that the direct normal sun intensity reaches almost 1,000 Watts/m² (or W/m²) at noon time. Therefore, a solar cell facing the sun directly at that time of the day would be expected to produce power which is close to Pₘₐₓ specification, assuming the temperature is close to 25° C. Since the east and the west facing verticals will directly face the sun in the morning and the evening respectively, the intensities during these times closely track the direct-normal intensity and almost reach 800 W/m² at both 8 am and 5 μm. The north facing cell is expected to receive about 100 W/m² most of the day from 7 am to 5 pm. Before 7 am and after 5 pm there is a slight spike as it may capture a small amount of slanting and/or scattered radiation from the sun when it is low on the horizon. The south facing cell sees a peak intensity of about 500 W/m² at noon time, but before 7 am and after 5 pm it merges with the north facing cell as the only radiation it is receiving is from the blue sky. FIGS. 4b and 4c show the modelled intensity on the vertical surfaces for E, S and W facing windows in Los Angeles CA. These figures show this for a clear day on June 15 and December 15. Since LA is in a lower latitude and is more representative of the sunbelt. The pattern is similar to that shown in FIG. 4a with the exception that there are large increase on the south facing window due to lower sun elevation in winter.

FIG. 5 shows very similar traces as FIG. 4a above, but are instead taken on an overcast summer day (Aug. 6, 1984) in Denver. As noted, the sun briefly causes some spikes in the morning through a thinned cloud cover. By and large all four directions show largely similar intensity profiles with slight increase for the east vertical in the morning for the south vertical towards midday and west vertical in the afternoon. The interesting point to note is that due to scattering from the clouds, the north facing vertical almost reaches 200 W/m², which is about twice as much as on a clear day, that is on an overcast day, it is possible for a north facing window to receive more scattered radiation as compared to a clear day.

Thus, on a clear summer day the solar light intensity on the windows (vertical surfaces) will generally vary from about 100 W/m² to 800 W/m² depending on the window orientation (i.e., the direction it faces) and time of the day.

Since FIGS. 4a and 5 are for a summer day, the modelling for Los Angeles in FIGS. 4b and 4c was done to check how the solar intensity will change with the varying seasons. This is to ensure that the intensities would allow us to generate enough solar power during winter. Even though the daylight hours are more restricted and the rise and drop-off in solar radiation is sharper during winter, we can normalize the peak daily solar intensities in August, mentioned above, by using daily average solar intensities for each month. As discussed above, this normalization would provide a conservative estimate on the south facing windows during winter. These monthly average solar intensities are published by “Solar Energy Local” for all states in US and for several cities within the US. The data in Table 4 are reported for Denver (https://www.solarenergylocal.com/states/colorado/denver/).

TABLE 4
Average solar intensity KW-Hours/m²/day
(KMD) for each month in Denver, CO

| | Average Solar | |
|---|---|---|
| | Intensity | Average Solar Intensity |
| Month | (K/M/D) | Ratio: Month/August |
| December | 4.78 | 0.75 |
| November | 5.46 | 0.85 |
| October | 5.85 | 0.91 |
| September | 6.48 | 1.01 |
| August | 6.4 | 1.00 |
| July | 6.53 | 1.02 |
| June | 6.5 | 1.02 |
| May | 6.21 | 0.97 |
| April | 6.2 | 0.97 |
| March | 6.27 | 0.98 |
| February | 5.57 | 0.87 |
| January | 4.97 | 0.78 |

As an example, for Denver, the peak of 800 W/m² intensity, mentioned earlier, for a clear day in August for an east facing window on a clear day in December can be estimated to be 600 W/m² (i.e., 800×0.75-600) using the ratios shown in Table 4. Even on winter days the windows need to be darkened to save energy if excessive solar heat is coming in, if a room has a large window facing the sun relative to the room size. Taking the Pₘₐₓ/m² of the various solar cells and the minimum light intensities falling on the vertical surfaces of the window one can create a matrix, as shown below in Table 5, in terms of power generation by the solar cell/module which is located on the window. This power is normalized to the area of the solar cell/module. Since the power generation for a solar cell is superior when the temperature is lower, the winter estimates of power generation, shown in Table 5, are conservative.

TABLE 5
Relationship between Pₘₐₓ/m² of a solar
cell, vs electric power generated

| | Solar Intensity W/m² | | | | | |
|---|---|---|---|---|---|---|
| | 50 | 100 | 200 | 300 | 400 | 800 |
| Pₘₐₓ/m² | Output electric power of Solar cell/module W/m² | | | | | |
| 150 | 7.5 | 15 | 30 | 45 | 60 | 120 |
| 200 | 10 | 20 | 40 | 60 | 80 | 160 |
| 250 | 12.5 | 25 | 50 | 75 | 100 | 200 |
| 300 | 15 | 30 | 60 | 90 | 120 | 240 |
| 350 | 17.5 | 35 | 70 | 105 | 140 | 280 |
| 400 | 20 | 40 | 80 | 120 | 160 | 320 |
| 450 | 22.5 | 45 | 90 | 135 | 180 | 360 |
| 500 | 25 | 50 | 100 | 150 | 200 | 400 |

For integration with a window, a solar cell/module with a certain Pₘₐₓ is selected and a solar intensity level is selected at which we want to generate sufficient power to darken the VTW, for wireless communication, processing, indicators, etc. Table 5 is useful to estimate the size of the required solar cell for a given sized VTW. For example, the estimated power required by a VTW product has been estimated to be in a range of 0.3 W to 5.1 W of power (for each square meter of window or active area, see next section on “Variable light transmission panel (or EC panel) and its integration in a VTW”). This includes all other functions, such as communication electronics processing, indicators, if used, etc. Considering the window-frame area available and the VTW power consumption, several choices may be made regarding the efficiency of the solar cells to be used, their size (area), or solar intensities where the windows should be triggered to reduce transmission, etc.

Further, if it was determined that the VTW consumed 0.3 W/m² of power (the lowest power requirement for the VLTP), then it should be capable of darkening once the solar intensity on the window reaches 100 W/m². If we were to use a solar cell which has a Pₘₐₓ/m² of 150, then to generate a power of 0.3 W for this solar intensity, the required solar cell size would have an area of 0.02 m²; and if a solar cell was selected with a Pₘₐₓ/m² of 500 is used then the solar cell size would be 0.006 m². When the solar intensity is higher than this threshold of 100 W/m², the excess charge produced can go to recharge the battery. This means that the minimum solar cell size required is 0.006 m² for each square meter of active window area (or 0.6%) using the highest efficiency solar cell from Table 5 which will trigger at a solar intensity of 100 W/m² on the window and will color the window.

Further, if the type of VTW used consumed 5.1 W/m² of power (the highest power requirement for the VLTP) then, a higher solar intensity may be selected to trigger the change so that the solar cell size is still reasonable. Selecting a triggering solar intensity on the window at 200 W/m² and using a solar cell which has a Pₘₐₓ/m² of 150, would require a solar cell size area of 0.17 m² to generate a power of 5.1 W; and if a solar cell with a Pₘₐₓ/m² of 500 is used then the solar cell size would be 0.05 m². When the solar intensity is higher than this threshold of 200 W/m², the excess charge produced can go to recharge the battery. From this discussion the largest solar cell area is 0.17 m² for each square meter of active window area (or 17%) using the lowest efficiency solar cell from Table 4 and a triggering solar intensity of 200 W/m² on the window.

In summary, the ratio of the solar cell size to the active window area ranges from 0.06% to 17%. However, using standard solar cells being used today with a Pₘₐₓ/m² of 250 the ratio of these numbers (i.e., solar cell area to the window area) would be in the range of 0.1% to 10%. Keeping the triggering solar intensity at 200 W/m², and a VLTP consuming an average of 3 W/m², the solar cell size required would be about 6% of the window area.

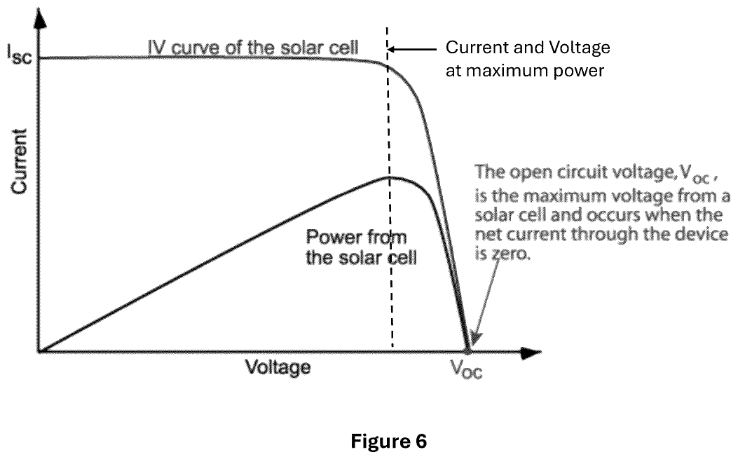

Solar cells which provide power may also be used as sensors for light intensity and measuring the outside temperature. Solar cells are characterized by determining their current-voltage (or I-V) curve by placing these under a certain level of radiation (or light intensity). The current is plotted on the y-axis and the voltage on the x-axis. FIG. 6 shows a typical I-V curve of a solar cell. The current value where the curve meets the y-axis is the short circuit current or I_{SC}. For well manufactured solar cells having low contact resistances with the solar cell electrodes, current value is almost flat, as shown in FIG. 6, and only starts dropping while approaching V_{OC}. V_{OC} or the open-circuit potential of a solar cell is the maximum voltage produced by the solar cell. Since at I_{SC} there is no voltage and at V_{OC} there is no current, no power is produced at these extremes. The maximum power generated by a solar cell occurs where the product of current and voltage is maximized, as shown in FIG. 6. Although the shape of FIG. 6 is similar for a broad category of cells, (single crystal silicon, multi-crystal silicon, amorphous silicon, Cadmium Telluride (CdTe), Cadmium Indium sulfide (CIS), Cadmium indium germanium sulfide (CIGS) and perovskites, etc.), their efficiencies are different and hence for a solar cell of the same area the Pₘₐₓ can be quite different when measured under STC.

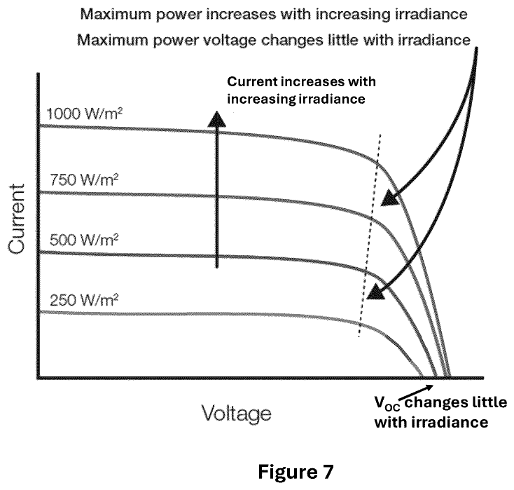

The I-V curve of a solar cell has an interesting dependency on light intensity and temperature. As shown in FIG. 7, with changing light intensity there is a large change in current or the I_{SC} and it almost varies linearly with the light intensity falling on the solar cell. The impact on V_{OC} with varying light intensity is much smaller. On the other hand, as shown in FIG. 8, V_{OC} shows a larger dependence on temperature where it decreases with increasing temperature, and I_{SC} is only impacted a little. For a given type of solar cell, V_{OC} is largely dependent on its intrinsic properties (band-gap and carrier concentration), which are influenced by temperature. One must be careful that this temperature is not the temperature of the ambient surrounding in which a solar cell is placed, but rather its temperature which is a function of both the ambient temperature and the rise in its temperature due to the absorption of light and the cooling effect it may be experiencing due to increasing wind on the surface if present.

For a given solar cell, I_{SC} can be easily measured by the electronic module connected to it and hence a determination of the light intensity can be made. In addition, the solar cells may even be calibrated in advance by measuring I_{SC} at different light intensities. Therefore, the solar cell may be used as a light sensor. When there are several solar cells on a window, one may average their values, or take the highest value. The latter can only be done if each solar cell is connected separately to the electronic module.

V_{OC} is also measured using the electronic module which helps in determining the ambient temperature (or the outdoor temperature in the vicinity of the solar cell) by using the following method). For this application, it is not important that a very precise estimate has to be made regarding the ambient temperature. A temperature resolution of ±3° C. or in another embodiment, even a temperature resolution of ±5° C. is sufficient to indicate the differences between summer to winter and also the seasons in between (see Table 6 for average temperatures in various seasons). V_{OC} measures the cell temperature (Tc), but this temperature increases with light absorption. Hence, to determine the ambient outside temperature (TA) the following equation (Equation 3) is used, where G is the solar radiation incident on the solar cell and determined by I_{SC} and a calibration table as discussed earlier.

$${T}_{A} = {T}_{C} - ( 20 - NOCT ) \times G / 800 \qquad ( Equation 3 )$$

NOCT is Nominal Operating Cell Temperature and is defined as the temperature reached by a solar panel under a set of conditions that are more in line with real world conditions other than STC. The conditions are, air temperature: 20° C., irradiance: 800 W/m² (at air mass: 1.5) and wind speed: 1 m/s. NOCT is provided by the solar cell/module manufacturer, as is Pₘₐₓ, which is determined under STC discussed earlier. Typically, NOCT is 20 to 30° C. higher than the ambient temperature (TA). For this application, in one embodiment, NOCT is determined by mounting the cell or module in a test rig similar to what may be used in a window frame and then using the NOTC test conditions. Alternatively, temperature information may be obtained from a temperature sensor mounted on the building, or on the window, or obtaining this information from external web/cloud sources, such as weather.com. One way of providing the temperature information to the VTW is to obtain this information through the user's remote, e.g., a mobile device connected to external web/cloud sources. Using the ambient temperature value several times during the day (or using stored data from the previous day or several previous days), an assessment can be made by the electronics regarding the season, and also draw a distinction automatically between morning and the evenings and clear vs overcast days. This information is then used to change the transmission or the SHGC of the VTW. A separate solar cell may be also used to measure temperature and light intensity.

### Variable Light Transmission Panel (or EC Panel) and its Integration in a VTW

The variable light transmission panels used in the VTWs have several functions. One of the important functions is to control the solar energy entering the buildings by darkening the windows. In addition, there may be times during the day when glare reduction or privacy is required. For these additional features, different levels of visible light transmission are needed, as discussed earlier.

The VTWs of this disclosure may have any kind of variable transmission panel even though they are made in different ways using different materials and have different working principles. Some of these variable transmission panels are based on materials which reversibly oxidize and reduce, such as those that have electrochromic dyes in the electrolyte, or those which contain electrochromic coatings (e.g., coatings containing tungsten oxide, nickel oxide, conductive polymers such as polythiophenes or covalently bonded electrochromic dyes in polymeric coatings) separated by an electrolyte. Some other variable light transmission panels may be based on different principles, such as those having particles which reversibly align in the electrical field including suspended particle devices, liquid crystal devices, or electrophoretic devices where the particles move in an electrical field. Any type of EC device may be used. In one aspect, a preferred embodiment is to use devices with EC dyes in the electrolyte due to their lower fabrication cost. These devices also offer additional attributes which make them attractive for this application.

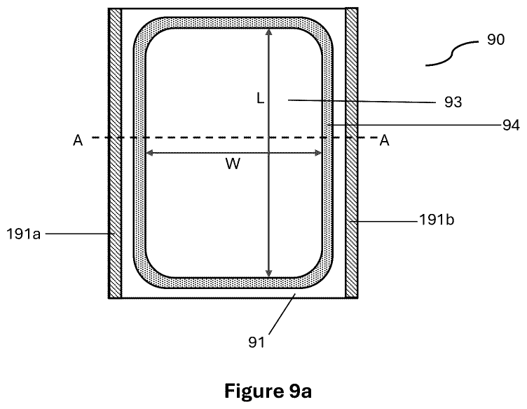

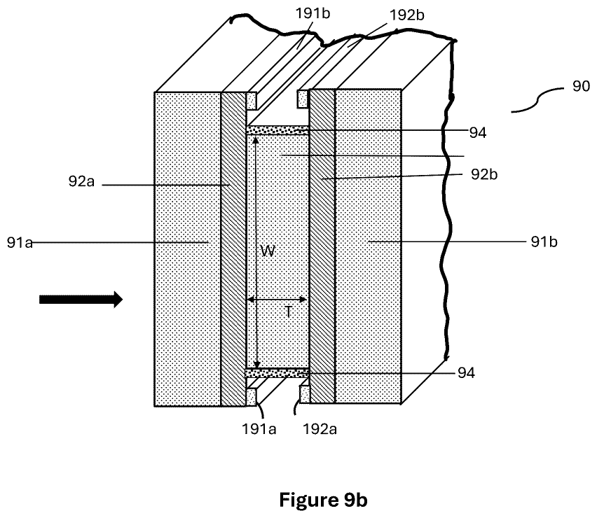

FIG. 1 shows a section of a VTW with an IGU formed by panels 12 and 13, and where the electrochromic panel is shown as 12. A schematic of an embodiment of an EC device (panel) with EC dyes in the electrolyte is shown in FIGS. 9a and 9b. This type of EC panel may be used as the EC panel of FIG. 1. FIG. 9a is the front view of the EC panel and a section along A-A is shown in an isometric view in FIG. 9b. This EC panel is made using two glass substrates coated with transparent coatings which are also electrically conductive (some examples of transparent conductors or TCs are indium/tin oxide (ITO) and fluorine doped tin oxide (FTO) and Aluminum/zinc oxide (AZO)). Sometimes the TCs may constitute of multiple coating stacks, such as thin metallic layers (e.g., silver) sandwiched within conductive oxide (e.g., ITO) and nitride layers (e.g., SiNx). In FIG. 9a, only the front view is shown, therefore, only the front substrate is shown as 91. In some cases, the sandwiched metallic layers may be patterned, e.g., like a mesh. Perimeter sealant 94 (shown both in FIGS. 9a and 9b) is used to make a chamber using these two substrates with the conductive sides facing inwards. The conductive sides on the substrates are also called the electrodes. Typically, the thickness of the electrolyte is shown as “T” (or the chamber thickness) 93 and is controlled by the perimeter sealant, and the panel may also have spacer beads dispersed within the sealant and the chamber (not shown). The electrolyte thickness is from about 25 μm to about 3,000 μm in one embodiment, in another it is between 100 μm to 750 μm. This chamber (with an average length of “L” and width “W”) has an electrolyte containing at least one electrochromic dye. Devices may also be made with an EC coating located on one of the TCs and at least one dye in the electrolyte. The electrolyte may be a liquid or a solid film, or the device may be assembled by introducing a liquid formulation between the two electrodes which is then polymerized to a solid. More details on such devices and dyes are found in published U.S. patent applications Ser. No. 20/230,043340 and 20220155648. These EC devices are simple in terms of their layer structure and can be assembled by obtaining coated glass substrates from third parties and assembling them into devices. The coatings do not require any further processing. Therefore, such devices also end up being low-cost, and their production could be automated by largely using conventional glass machinery. Edge busbars shown as 191a-b and 192a-b in FIGS. 9a-b are in electrical contact with the TCs 92a and 92b, which are deposited on transparent substrates 91a and 91b, respectively. The busbars are made of highly conductive materials such as silver frits, metal tapes, conductive adhesives (e.g., silver filled epoxies), metal coatings which are not transparent. These busbars are orders of magnitude conductive as compared to the TCs comparing their surface resistivities. The surface resistivity of the busbars is at least 100 times less as compared to the surface resistivity of the TCs. Busbars are connected to the electrical wires to power the devices and these busbars help in distributing the voltage uniformly across their lengths. The thick arrow in FIG. 9b shows the direction of the solar energy falling on the window, i.e., substrate 91a faces the sun.

The electrochromic device may be laminated to an additional substrate(s) using e.g., polyvinyl butyral (PVB) films to impart superior impact resistance for safety and also to provide protection from the solar UV, and/or these substrates may be further tuned to have certain desirable color and reflective properties. The additional substrate may be tempered or heat strengthened. In one embodiment, by using this lamination the following UV blocking properties are achieved; at least 99% of the solar radiation below 405 nm is blocked, and in another embodiment at least 99% of the solar radiation below 390 nm is blocked. FIG. 10 shows an IGU construction of a window with a laminated EC panel. The EC panel 105 is laminated to a glass 1010 using an interlayer film 1011. The low-e panel comprises a glass substrate 102 and the low-e coating 103. The laminated EC panel and the low-e panel are separated by a gap 104, which is gas filled or evacuated, as discussed earlier. The spacer to maintain the gap between the two is shown as 101a, which is bonded using an adhesive 101b to both the laminated EC panel and to the low-e coated substrate. The thick arrow shows the direction of the sun. Also, without counting the substrates and interfaces in the EC or the low-e panel, and only counting the surfaces that contacts air, gas or vacuum, are labeled as 1, 2, 3 and 4 starting from outside as shown in FIG. 10. Thus surfaces 2 and 3 face the gap and surfaces 1 and 4 face outside and inside the building respectively. The issue of color and reflective properties by using this lamination is discussed in detail in US patent U.S. Pat. No. 11,649,670B2, which is incorporated herein by reference. A unique aspect of the teaching of the above patent is that the third substrate imparts enhanced reflectivity and/or tint so that when the EC panels darkens to change its optical transmission, during the daytime the change in the reflected color of the VTW when viewed from outside is not noticeable. Specifically, When the VTW is darkened so that so that its optical transmission, when measured at 550 nm, decreases by a factor of 10 from its clear state (optical state 1) to the darkened state (optical state 2), then the color difference of the reflected light between these optical states ΔE_{R}* is less than 10 (dimensionless) when viewed from the outside; wherein ΔE_{R}* is the color difference according to CIELAB in reflection in the two optical states, wherein this is calculated as the Sqrt {(L₂*−L₁*)²+(a₂*−a₁*)²+(b₂*−b₁*)²}, wherein L₁*, a₁*, b₁*, L_{2*}, a₂*, and b₂* are values as defined by CIELAB to represent lightness and color of the reflected light in the two optical states.

EC devices with dyes in the electrolyte are routinely used in automotive rear-view mirrors, as they provide low-cost assembly and, in case of power failure, they provide enhanced safety by automatically transforming from the dark to the clear or the bleached state (or are self-erasing). Since these devices constantly consume electrical power to maintain their colored state, the electric current component of the electrical power upon reaching a steady state of current is termed as leakage current. At this point the VTW also reaches a steady state of coloration, tint or darkness for a given powering voltage. For example, if an EC device is powered at 1.5 volts to darken and reaches the steady state current and consumes 100 mA (or 0.1A) of current, then this current is termed as “leakage current”, and the concomitant “leakage power” or power to maintain this optical state would be 0.15 W (calculated as 1.5×0.1=0.15). These mirrors have high leakage current as the self-erasure time period is only a few seconds, as the car may be moving and the mirrors need to react quickly. At room temperature (nominally 25° C.), the leakage current for mirrors exceed 180 μA/cm² of active area and may approach 800 μA/cm². The “active area” of EC panel is the area which colors after subtracting the area covered by the busbars, sealants, etc., from the panel area. As an example, in FIG. 9a, the active area of the EC device 90 is L×W. Generally, the daylight area of a window is slightly less than the active area, but it is quite close. If no information is available on the active area, the daylight area (the visibly clear area of the window within the frame) may be taken as a close approximation of the active area.

An important aspect of the VTWs on buildings is their safety in emergency situations, where it is important for the windows to clear up automatically if there is a power failure. Therefore, it is desirable to have these windows become clear if there is a loss of power. For this to happen, it is important that the windows consume power to maintain the darkened state, as they clear up when there is a power failure, as there is no power to maintain that state—a property also called self-erasure. As discussed below, the EC devices having at least one mobile electrochromic dye in the electrolyte naturally possess this feature. Generally, these EC dyes are organic or metalorganic. As will also be discussed, requiring too much power to maintain the colored state is detrimental to creating economical large-area devices (such as building windows), and to being able to power these effectively and economically using solar cells in the window frames. An emergency situation can be wirelessly communicated to the windows so that self-powering to the windows is turned-off.

One way of imparting the self-erasing property is by incorporating at least one electrochromic dye or a redox material that is present in the electrolyte and is mobile. Mobility means that this material can travel from the electrode to the center of the device. This means that the dye is able to travel through the electrolyte and reach an electrode and then also travel into the electrolyte. During coloration, the dye(s) form a charged species by reducing or oxidizing to a colored or a darker state at the electrodes. Then, these charged species migrate into the electrolyte. When these charged species of opposite polarity meet each other within the electrolyte, they exchange an electron and revert back to the colorless neutral state. The mobile charged species may also travel to the opposing electrode through the electrolyte and neutralize a charged species in the opposing electrode. If the electrical power from the device is removed, then given sufficient time, all of the colored species meet an oppositely charged species to a neutral state, which results in an optically clear device. Hence, these devices require constant power or have a leakage current to keep them in the darkened state. When one or more dyes are incorporated within the electrolyte, at least one is able to travel through the thickness of the electrolyte. However, the devices used for the automotive mirrors discussed above are not suitable for large area devices, which are required for architectural applications. This is because these leakage currents are too large and unsustainable with increasing device area. With increasing device area, particularly with increasing “W” (see FIGS. 9a-9b), that is the distance of the active area between the perimeter busbars, this causes the voltage to drop sufficiently towards the center of the device, which results in no coloration or faint coloration in the device center, called “iris effect”. This voltage drop can be addressed by internal busbars, but that increases the device cost and power to keep them in the colored state may be too high for the power to be supplied by solar cells. For EC panels, particularly for architectural applications, “W” is typically equal to or greater than 25 cm, in another embodiment this is greater or equal to 50 cm and yet in another embodiment this is equal to or greater than 0.9 meter and in a further embodiment to be greater than 1.2 m.

Some leakage current is required for the self-erasing property of the EC devices, and on the other hand, too much leakage current causes iris effect in the windows. Also, as discussed later, too much leakage current will require a large solar cell, which may be expensive or cannot be accommodated easily in the window frame, and the limited battery capacity/physical size within the window frame may not be able to support to maintain the colored state of the EC device too long if there is a decrease of instantaneous solar power. The iris effect can be reduced by increasing electrical conductivity or reducing surface resistivity (SR) of both the electrodes. For monolithic TCs comprising ITO, FTO, AZO, etc., decreasing SR results in more expensive electrodes and decreases optical transmission. Monolithic TCs means that there are no highly conductive underlying metal coatings or meshes. So wherever possible, electrodes with the higher SR are preferred if the iris effect is not seen in the desired window size. In general, surface resistivity (“SR”) of the monolithic TCs for use in windows is in the range of about 1 to 20 ohms/square. In another embodiment, this range is about 2 to 8 ohms/square and in a further embodiment in the range of 3-7 ohms/square including the extremities. When the resistivity of such conductors drops, so does their solar transmission, thus the VLTPs in the clear state have lower SHGC. Therefore, it is preferred that for this reason and increased cost of lower surface resistivity TCs, to use a TC with the highest surface resistivity that does not result in an iris effect. Multilayer TCs with metallic interlayers protected with conductive dielectrics (e.g., ITO, AZO, silicon nitride, etc.) may be used where the surface resistivity is lower than 1 ohm/sq (e.g., down to as low as 0.1 ohm/square) and still have high optical transmission (typically greater than 60%), but devices with high anodic potentials may lead to the metal layer corrosion (oxidation), particularly when there may be an inadvertent pinhole in the protective dielectric layer. Therefore, for the large-area EC devices fabricated using TCs having the above-mentioned SRs and which will demonstrate self-erasure in a reasonable time and not show an iris effect. For achieving this in large area devices, the leakage current at room temperature (nominally 25° C.) should be in a range of 5 μA/cm² to 120 μA/cm². In another embodiment this range is between 15 μA/cm² and 60 μA/cm². Since the leakage current is temperature dependent, the leakage current values as used herein are stated at room temperature (nominally at 25° C.). If intermittent power is used to maintain the darker optical state, then to obtain the LC, the lowest current is averaged over several periods of intermittent power cycles. Prior to fabricating the large-area devices, the leakage current can also be determined from small devices (e.g., “W” being <10 cm) which color uniformly when powered. This is done by applying the desired coloring voltage to the device and letting it reach steady state current, and then measuring the current and dividing this by the “active area” to yield the leakage current/cm². To establish leakage current (Lc) it is preferred that the TC surface resistivity of the small device is the same as the large device and also the electrolyte composition and thickness is the same that is to be used for the large devices.

Further, in EC devices, in addition to the leakage current, the kinetics or the rate of darkening and bleaching of the VTWs should be reasonable. The coloration and the bleach rates in a device may not be symmetrical, but substantial changes in the level of coloration should be seen within 20 minutes in one embodiment and in less than 5 minutes in another embodiment. Substantial change refers to 80% of the optical change should happen in this period. In general, this transmission is measured in the center of the device, or at least equidistant from the edge busbars (close to the center of the width W as shown in FIGS. 9a and 9b. The optical transmission of the window may be measured at 550 nm (peak of photopic eye response) or visible light transmission, which is an integrated transmission between 400 and 700 nm weighted by a normal photopic eye response. Usually, these numbers are close to one another and may deviate by a small amount when the transmission at 550 nm is quite different from other wavelengths in the colored and bleached states. As specific examples, taking an EC panel (or a VTW) which in its fully clear (or bleached) state has a VLT of 75% and for a given powering protocol, in its most colored (or darkest) state the VLT is 5%, then 80% of this range is 56% (as calculated by, (75−5)*0.8=56). Therefore, in the above time periods the panel should color in the center from 75% to 19% (as calculated by, 75−56=19) and the same goes for the bleaching rates, where the bleach times are measured from its darkest point, that is the time period where the VLT changes from 5% to 61% (56+5). When there is a power failure, the windows (VTWs) would automatically start self-erasing or self-bleaching as seen by their increasing optical transmission. Further, in the self-bleach mode at room temperature, they must achieve a VLT transmission (or transmission measured at 550 nm) of 80% of the range within an hour, and in other embodiments, in less than 20 minutes. Please note this self-bleach rate may be different from the bleach-rate following an instruction to bleach. As an example, if a window is in its darkened state, showing VLT of 1%, and its clear state is 61%, then 80% of this range is 48% (i.e., 0.8×(61−1)=48), which means that the window must achieve a transmission of 49% (1%+48%=49%) in the prescribed time. The optical transmission values are typically measured at the center of the windows.

The desired values of the leakage current provide an insight on how to size the solar cells and batteries with respect to the EC window active area. Table 4 listed earlier on the wattage that could be produced by the solar cells when incorporated into the windows. Taking the extreme of the leakage currents, a VTW with an active area of one square meter would require a leakage current of 0.05 A or 1.2A based on the limits of 5 μA/cm² to 120 μA/cm² respectively. Furthermore, this leakage current is only to maintain the dark state. However, more power is consumed during initial stages of coloration. Once the EC cell has been darkened, then the extra power from the solar cell may be used to recharge the battery. Considering power loss and other inefficiencies and including power consumed by any sensors on the windows, the above requirements of current leakage are conservatively multiplied by two to obtain 0.1 and 2.4A for each square meter VTW. The EC devices are typically powered to achieve their coloration between 1 and 3V. Assuming an average of 2V, the minimum power required from the solar cells to keep the VTW panels colored (not accounting for communications or any other electronic features) would be from 0.2 W to 4.8 W/m². Once all of the power requirements are assimilated together, Table 5 will be used to size the solar cell required and will also depend on the minimum solar intensity (in W/m²) falling on the windows at the trigger point. Trigger points are discussed below in the sections on “Self-regulating windows” section and in “Solar cell size requirements and their use as sensors”. The requirements for the battery sizing are discussed in the “Centralized networks, energy saving estimates and sizing of solar cells and batteries” section.

This trigger point is determined by considering the solar intensity falling on the window, and by how much the SHGC/VLT can be reduced. A general range of SHGC variation ratios (Highest SHGC divided by the lowest SHGC) for VTWs is about 1.8 to 10. For example, for the VTWs shown in Table 3, this ratio for “SageGlass Clear with SR20” is about 4.6, i.e., a change in SHGC from about 0.41 to 0.09. This means that when the windows are subjected to the highest expected intensities falling on the windows, as discussed earlier, (also see data in Table 5) of 800 W/m², then at the lowest SHGC of 0.1, the windows would allow about 72 W/m² of radiation to penetrate inside the building. Hence, based on this acceptable number of solar transmission in the dark state, a trigger point of greater than 72 W/m² or greater falling on the window would be adequate. Therefore, 100 W/m² to 200 W/m² of solar intensity for the windows to respond may be taken as an acceptable trigger point. This also means that from an energy saving perspective, north facing windows in buildings in large parts of the northern hemisphere may not require VTWs, but rather have a standard window with a fixed optical transmission as the potential to save energy using the VTW in this direction would be limited (see the trace for “Global North Vertical” in FIG. 4a).

FIG. 3 shows salient features of a VTW along with the electronics and other components of an embodiment which is placed in the window frame. Each of the electronics along with the associated VTW are collectively referred to as an “eWindow.” This receives power from the solar cells discussed above and the Power Controller & Modulator (PCM) converts the signal appropriately to charge the battery, or it may convert to the appropriate potential to apply power to the Master Control Unit (MCU or the controller). This may also be configured to both charge the battery and power the EC window when there is enough solar power, and when it is dark and the solar panel is not producing power, it taps the battery if the panel needs to be switched, as needed by the user or the window. Switching power supplies may be used wherever possible to step-down or step-up the potential to conserve power. The Master control unit applies power to the VLTP (or the EC panel). The voltage-time profile provided by the MCU to the EC panel depends on the type of EC panel used, and may also depend on several other factors, such as extent of coloration required and any algorithms used to extend the longevity of the EC panel. For those EC panels where a redox (oxidation and reduction) activity occurs in the panels for coloration (darkening) and bleaching, typically the maximum voltage is less than about ±5V and is DC. For those EC devices which use electrochromic dyes in the electrolyte, the voltage range for coloration is generally less than ±2V. In some types of variable transmission panels, high frequency AC voltage may be used and in such cases an invertor is used to change the DC power to AC power, as long as the power consumption is in a range that the solar cells/battery are able to provide. The dotted enclosure in FIG. 3 shows each VTW having an EC panel, a solar cell, optional sensors (such as outside temperature), PCM and NCU along with a battery. The PCM, Battery and the MCU are contained within the window frame. The optional sensor and the solar cell are also located on the window. All of this is called an eWindow. FIG. 3 also shows that this eWindow is wirelessly connected to an eWindow mesh, which is a collection or a set of windows forming a cluster which may be all of the windows in a room facing a certain direction or on a particular wall, as discussed above. A plurality of these window meshes, each containing more than one window, may be formed by the user in a building. When this is done, then for control purposes, the user may select one of the e-windows to decide when to trigger the change (i.e., a master window), and all of the other windows (slaves) in that cluster wirelessly couple to the master window and simultaneously follow its lead. Another configuration is to average the trigger signals (such as solar intensity, outside temperature) within a cluster and use that as the trigger point. Alternatively and optionally, these meshes may also be hooked to a Gateway, which may provide specific instructions based on user input.

As discussed below, there are many modes in which these panels may be configured to darken. To keep the disclosure streamlined these will be principally divided in two modes, self-regulating and network controlled, although as would be evident from the discussion below, there could be several overlaps between the two modes. For windows in the self-regulating modes, the wireless signal is optional in certain embodiments, as discussed in more detail below.

### Novelty of Self-Regulation, Cost, User Interaction and Networking

In order to enable a wide adoption of the VTWs it is important that their costs are low and the installation is simple and comparable to standard (static or fixed SHGC) windows. The installed cost of conventional VTWs windows and their repair is high as they also require electricians for wiring and repair, in addition to the high conventional VLTP costs used in these windows. Use of such windows is particularly expensive in a retrofit situation where wiring from the main building has to be brought in to the windows and connected. Thus, wireless windows, where the electrical power source is within the window are highly desirable. It is not only important to have a power source in these windows, but each of these windows is self-contained in terms of control and key functionality. This also becomes an important issue for economical replacement/repair as discussed below. Furthermore, any kind of EC technology may be used for the VTWs of this disclosure. EC panels (VLTPs) which contain electrochromic dyes within an electrolyte are more desirable due to their lower cost.

Different windows or window sets in a building may be activated differently or at different times as these face different directions and are in different rooms which serve different functions (e.g., a bedroom, living room or a kitchen, etc.). Furthermore, some windows may never face direct sun (e.g., north-facing window in northern hemisphere) while some may face direct sun for some number of hours, while others may be shaded by overhangs, shadows of other structures or vegetation nearby. All this will also change with changing seasons as the sun direction changes, changes in trees nearby as they drop their leaves, or when they are removed, etc. Further, each building wall or room wall may have several windows facing the same direction and may also be located next to each other, which may comprise a set or a cluster of windows. It may be important to the user that a particular set of windows darken at the same time, and another set of windows in a different room or direction may not even be activated (or triggered) for a simultaneous change in optical transmission. Therefore, a set of windows may be linked or networked together in a cluster to be activated at the same time. The user should be able to wirelessly link or delink a set of windows together so that they respond at the same time in a similar fashion. This assumes that the solar cells/battery attached to each of the linked windows are able to provide sufficient power. More about this kind of control and integration with sensors is taught in the next section. At any given moment and in a given building, it is important to be able to control the optical transmission of the different windows (or a set of windows) to different extents and provide energy savings, comfort, effective glare control and desired functionality to the user.

Since electrochromic windows require electrical power to control the optical transmission, hard-wiring of these windows for connecting to building power is to be avoided for a complete wireless solution. A wireless window means that it is not connected by wires to a power source external to the window (window includes the window frame). Further, it is desirable to form a network of a set of windows which wirelessly communicate with each other and the user. Therefore, in such embodiments, a power source must be located within each window, and it is desirable to include solar cells as a power source which are integrated within the window (either within the IGU or the window frame or both). The solar cells should be sized so that they can provide enough power to power the EC panels and wireless communication. To ensure that sufficient power is available instantaneously when the lighting conditions on a window is not adequate to generate enough power, an optional rechargeable battery may also be incorporated within the window along with the electronics (or electronics module or a control system). This module is responsible for charging the battery from the solar cell, and appropriately powering the EC cell and also providing power for any communication for the network and/or the user. The power may also be optionally augmented by other types of systems such as thermoelectric devices capitalizing on the temperature difference between the inside and outside of the building, or piezoelectric devices converting mechanical vibrations into electricity. Use of solar cells as the local power source is a preferred embodiment in this disclosure.

Solar cells and the electronic control system may be integrated within the IGUs or the window frames. Either method may be used, the advantage of the former is that window frames do not have to be modified to accommodate the solar cells, but the disadvantage is that any replacement or repair of solar cells is difficult and the IGU or the entire window will have to be replaced. In a preferred embodiment, the solar cells and the associated electronics (electronics module) are integrated in the window frames in a way so that these components may be replaced without even removing the window or the IGU from the building. Further, these solar cells should be easily detachable from the electronics which are also located within the window frame using a quick disconnect.

In some embodiments, the electronics may have LED (light emitting diodes) indicators which show through the frame to convey the status of the VTW to the user. LEDs are preferred indicators due to their low power usage. These may also be turned on and off with a certain frequency to lower their power consumption, or these may be turned on for a small duration (a few seconds to minutes) when these windows are interrogated or their status is changed by the user. It must be understood the communication using the LEDs with the user is also wireless, but it is optical in nature. The user may also be notified wirelessly through a mobile application (an App).

In an important embodiment, particularly for energy savings and automatically controlling and varying SHGC, the optical transmission of the windows is self-modulating not only responding to the solar intensity falling on the window but also considering outdoor temperature, and optionally other inputs. An important aspect of the wireless windows is they also derive all of the power for communication from the power source located within the window and are not connected to the external sources and do not share power with the other windows. Each window may be named or assigned a unique ID. The user interaction with these windows is wireless by a remote or an app from any mobile device (e.g., phone, tablet, etc.).

There may be several use cases for the self-regulating windows of this disclosure and these may also be combined as required, some non-limiting examples are:
a. Each VTW has its own sensors and intelligence built-in (or “integrated”) so that each VTW can respond to the outside conditions automatically (“self-regulate”). As an example, each window in a building may have its own temperature and light sensor to measure the external conditions. The electronics and the battery integrated with each window derive power from the solar cell. Based on an algorithm, the electronic module powers the window to automatically adjust the solar light transmission of the window. If the windows do not have to be powered under low-light, then batteries to store power for EC may not be required by appropriately sizing the solar cells.
b. The user may change the parameters for the self-regulated behavior by including additional parameters and/or overriding self-regulation for a period of time. The user may also be able to wirelessly link a set or a cluster of windows together so that a specific cluster responds simultaneously and/or similarly. Different clusters in the building may take a different action by not dimming or dimming partially because sun direction is different relative to that cluster. Further, a user may prefer to control the light in a room or a building depending on the task/activity at hand, and may override some of the energy saving protocols by darkening the windows or clearing them more during certain parts of the day (e.g., sleep, or having enough natural light to carry out a task so that energy for lighting may be reduced, etc.).
c. The user may also set different requirements/parameters on different windows, as the instructions may be to keep the windows dark in a particular room until late on the weekend mornings.
d. In one embodiment a manual switch (or a wirelessly activated switch) is provided on each window to turn the power off to the EC panel so that it always remains in its native state (clear for EC cells with dyes in the electrolyte) or goes into a self-regulation mode subject to further fine tuning by the user as described above. The window or the window frames may only have LED indicators showing their status or if there is a malfunction. In case of malfunction, the error code could be retrieved wirelessly.
e. In many residential buildings, during the weekdays, the occupants (user) may leave in the morning and be away for a substantial amount of time during the day. This presents an opportunity, on warm and bright summer days, where the windows may be left in an energy savings mode and they darken during this period to reduce the solar energy infiltrating into the building and prevent the objects inside from heating and reducing the thermal mass to be cooled. Therefore, lowering SHGC during bright and warm days preserves a comfortable building temperature without expending too much cooling energy. Furthermore, maintaining a lower interior temperature during the day, preventing walls and floors inside from being exposed to direct solar radiation will reduce entrapped heat or thermal mass. When the occupants return in the evening and trigger a lower temperature setting, the cooling is more efficient and requires less energy. Similarly on bright winter days, the windows may be controlled to a more transmissive state to heat the interior during the daytime. Managing peak hour energy consumption also helps the utilities in planning their power production and the consumers by lowering their electricity costs.

Although these self-regulating windows are independent of each other, in another embodiment, they may also be tied into networks wirelessly to receive commands and/or information on certain parameters from a centralized location. For example, if a user leaves a building and turns on the intruder (building) alarm that would send a signal to all of the windows that the building is going to be unoccupied and hence a different control logic needs to be used to conserve energy or to enhance privacy depending on the users' desires. These windows can be placed on a network which remembers the orientation, placement, and external shading of each window and then appropriately act on the light transmission of each window to deliver the user a superior experience at a lower energy cost. Another factor that may be incorporated is predictive weather conditions and the position of the sun. For example, for an east-facing window during summer, if the sun is scheduled to hit the window with strong sunlight at 7 am, then the window may be programmed to gradually start reducing its optical transmission before that time and keep on decreasing the darkening further as the solar radiation intensifies. Artificial intelligence (AI) based algorithms may be used for predictive and/or adaptive changing the control parameters with weather, season, etc. to get most energy saving benefits from these windows.

This electronics module on the window may also wirelessly communicate with an optional gateway and even perhaps with the other nodes (e.g., other windows, window clusters and devices in the network), user interface or the network in general. A gateway in a wireless network is a centralized unit which connects with the user, other windows, building automation systems, devices and the cloud, internet etc. The other optional input may include the temperature inside the building or the room with this window. Furthermore, the control of the optical transmission through the VTW could be coupled with other inputs such as occupancy sensors, building alarm, etc., to determine the presence of an occupant in a particular room or inside the building so that a different set of considerations may be used other than for optimizing the energy use only. It is understood that, throughout this application, the “cloud” refers to a network of remote servers hosted on the internet that store, manage, and process data, rather than relying on a local server or personal computer. The cloud may provide, for example, on-demand access to a shared pool of configurable computing resources, including networks, servers, storage, applications, and services.

In some embodiments, and as described in greater detail below, a self-regulating variable optical transmission window comprises at least one insulated glass unit (IGU), wherein each IGU comprises at least one variable light transmission panel (VLTP), wherein a change in optical transmission of the window is activated by applying electric power to the VLTP; a window frame present around the perimeter of each IGU, wherein each IGU comprises a solar cell and an electronics module, comprising a control system for the VLTP, optionally for control by a user; wherein the electric power for the VLTP and the electronics module is produced by the solar cell. In some embodiments, the window is wireless. In some embodiments, a rechargeable battery is connected to the electronics module. In some embodiments, the electronics module further comprises a wireless communication system. In some embodiments, the wireless communication system provides access to a window control system.

In some embodiments, self-regulation of the window is achieved by responding to at least two factors: (1) the intensity of the solar light falling on the window; and (2) the ambient temperature outside the building envelope, wherein the control system applies the activating electric power to change the optical transmission of the VLTP when the desired combination of the factors is reached. In some embodiments, self-regulation of the window is achieved by responding to at least one additional factor selected from: ambient temperature inside the building; light intensity inside the building proximate to the window; motion outside the building proximate to the window; and occupancy of the building In some embodiments, the intensity of the solar light and/or the ambient outside temperature is measured and/or determined by the solar cell.

In some embodiments, a user will interface with one or more windows. In some embodiments, the user will interface with a network of windows, comprising one or more windows. It is understood that the term “window” used herein can also encompass a “network” of windows. In some embodiments, each window of a network may interface with one or more windows of the network. In some embodiments, each window in a network interfaces with every other window of the network.

In certain embodiments it is not convenient or even desirable to provide a user interface for each window individually (for example, via a pad or a screen), but it is superior to provide a centralized command from a dedicated user interface, a remote, a computer or a mobile device, such as a phone. The mobile device may interact with a single window, a plurality of windows individually, or a network of windows, either directly or through a centralized unit (gateway) which also interacts with the windows directly. The communication within the windows is wireless. This communication allows the window or network to utilize data provided non-locally, for example, data from the cloud, by wirelessly communicating through the user interface.

The windows of this disclosure may be installed by conventional glaziers or contractors, and any maintenance/replacement is local and could be performed by the user without having to physically disconnect an electrical connection external to the VTW. In addition, when one or more windows is part of a network, the network allows said windows to be integrated with one or more additional sensors and inputs. These sensors or inputs include, for example, lights, occupancy sensors, indoor and outdoor temperatures and illumination, HVAC systems, weather stations, utility grids, work pattern of the occupant, etc. The sensors or inputs may enhance the energy efficiency of the building and occupant comfort. Moreover, the sensors or inputs may be located close to the window or network of windows, or not. In some embodiments, the sensors are located inside the building, outside the building, within the building HVAC control system, within the building automation system, within a cloud, within an electric utility worldwide web service, within a personal digital assistant; or within a phone app.

### Self-Regulating Window Control Mechanisms and Window Clusters

The light falling on the windows is determined and then this information is used to self-adjust or control the amount of solar heat transmitted through the window. The power to tint the window is derived from a local source such as a solar cell located on the window and/or the rechargeable battery, which is also present within the eWindow. The logic to tint and power management is all part of the electronics which is also present within the eWindow, as discussed earlier. In one embodiment, this window also considers the ambient outside temperature as an input. In this mode, the principal function of the windows is to save energy and/or to provide the user (occupant) with increased comfort. As discussed below, this self-regulation may apply to each window or a set or cluster of such windows networked wirelessly. As disclosed in Table 2, in the latest Energy Star ratings, the US has been divided into four climatic zones and to improve energy of buildings using energy efficient windows, each zone has certain requirements for SHGC and the U values. In the future, changes to Energy Star programs may require additional (or finer) divisions within these climatic zones. Using VTWs, the change in optical transmission causes SHGC to change with almost no effect on the U value. Therefore, the energy efficiency of VTW windows is improved by dynamically varying the optical transmission or SHGC to suit the instantaneous outdoor condition of temperature and brightness. As an example, in the southern zone the requirements for the U value and the SHGC from Table 2 are ≤0.32 and ≤0.23 respectively.

In some embodiments, a VTW can be designed by incorporating one or more low-e coatings, the IGU gap and the fill for the gap to achieve a U value of less than 0.32. However, at least two SHGC modes are selected depending on the optical transmission of the VTW (or the variable transmission panel used to form the VTW). In one of these modes, SHGC is lower than 0.23. In the other mode, it is desirable for it to be higher than 0.23 to let more sunlight in the winter. This means that this window will be more efficient in summer as compared to a fixed SHGC window of 0.23, as it can self-regulate to a SHGC value lower than 0.23 and also more efficient in winter due to its SHGC (higher than 0.23). There may be other optical states in between (meaning more than two optical states), if the variable transmission panel allows for a gray (or intermediate) state to be selected. More details regarding the working principles of a self-regulating window are discussed below.

As used herein, when reference is made, for example, that the solar intensity on the window is 500 W/m², this means that the intensity on the windows in their vertical orientation as being measured by the photosensors or the solar cells. It is to be noted that this is different from the intensity measured by placing the sensor normal to the sun. If there are several sensors or solar cells/modules in a window, then this number maybe an average intensity on the solar cells. Ff they are connected separately, located in different parts of the window (e.g., bottom of the frame, and on the left and right sides of the frame) and connected individually to the electronics, then the highest intensity may also be used to determine this value. In other words, the solar intensity on the window for self-regulating wireless windows is determined by the solar cells and/or photosensors or light sensors located on the window (located on a window includes the window frame).

In this embodiment, once the windows are installed, the windows start regulating the SHGC depending on the seasons (primarily temperature based) and the solar intensity following a prescribed program which has been pre-determined for that local geographic area. The initial parameters may be inputted at the factory, by the window installer, an authorized service person, or the user depending on how the windows are configured to be used The windows may be programmed by the service providers from a remote (off-site) location. Since no wiring is required, this window is installed as an ordinary window. As discussed earlier in the “Solar cells: Solar cell size requirements and their use as sensors” section, in one embodiment, the solar cell itself may be used as both a temperature sensor for the outdoor ambient temperature measurement and also as a light sensor to determine the solar radiation on the window. In other embodiments, these inputs may be provided by having additional sensors on the window or externally. As an example, the electronic module may be programmed differently for three settings for the seasons, setting 1 for summer, setting 2 for fall and spring and setting 3 for winter (please note that there may even be more than 3 settings, e.g., monthly settings, or dynamic settings which change based on the seasonal changes). These settings could be programmed locally for each region within each of the Energy Star zones (see Table 2), e.g., a subzone within Southern Zone may be at an elevation which experiences weather similar to North Central Zone. The user may also cluster the windows to form different wireless networks within a building so that each cluster responds to the same command. A set of exemplary settings are shown below in Table 6 for a local area in Southern Zone, where each setting has three set points, outside ambient temperature (TA), Solar intensity on the window and the season. An example of these settings is provided below. It must be understood that a person skilled in the art would be able to change and select these set-point numbers as needed. The season setting may be done in several ways, in one method, a timer or an annual clock is built in the electronics and the seasons are referenced to the dates. In another method, the maximum temperature (TA) is stored for the past several days (e.g., 3 to 15 days), and based on its average a determination is based on the prevailing season at that time. In the second embodiment, it means that the electronics self-determine the season and then accordingly picks the temperature and the solar intensity trigger points from the table.

The windows can self-regulate depending on the season of the year. Regarding Table 6, in summer (or when the electronics determines that it is summer) the trigger point for darkening is a minimum ambient temperature of 25° C., and the minimum solar intensity of 100 W/m², and the windows continues to be in the darkened state while the solar intensity remains higher than this setting. Such a profile would limit the solar heating of the building interior. In winter, the trigger may be set at any temperature, such as 10C as shown in Table 5 and the solar intensity being 600 W/m². If the temperature is lower than 10C, then all of the solar energy is allowed to enter subject to the SHGC of the clear VTW, which will enable the solar radiation to heat the interior. However, even if at 10C or at a lower temperature the solar intensity reaches 600 W/m², the window will darken. According to the parameters used (or desired by a user), when a combination of these two factors, which in this case is the outside temperature and the solar energy falling on the window is reached, the window is electrically activated to go to a different optical state. As discussed earlier, outside ambient temperature may be substituted by a clock located in a self-regulating window (e.g., in the electronics module present in the window) to provide the information on seasons. The clock that keeps track of an annual calendar may also be used to provide information on the month or perhaps even the day of the month. This information is then used to imply a certain average seasonal temperature that is used for ambient outside temperature determination. Average temperatures for different days of the year are programmed in a table in the electronics module. For energy savings, at the time of installation, the window direction may be programmed, so that the clock may even be used to change the transmission of the windows at specific times (time of the day)—a substitute for measuring the solar intensity on the window. However, it is preferred that temperature and solar intensity are measured so that the measurements can also account for a change in weather conditions and/or shadows falling on the window.

There may be additional intermediate levels of setting depending on the type of VLTP used. If it is capable of being controlled at different optical transmission levels (gray-level tint control, rather than only clear and dark), then there may be several trigger points determined by the solar intensity, where increasing solar intensity will cause an increasing level of darkness, which will automatically result in windows demonstrating several levels of SHGC. In another control method, self-regulation may be used to primarily control glare and/or privacy, the solar intensity or a visible light sensor may be used. For example, a small solar cell covered with an optical photopic transmission filter may be used as a visible light sensor, so that only the light sensitive to human eye passes through this filter. Optionally the light falling on the solar cell may be taken as an indication of brightness without having to measure visible light. In the glare reduction mode, the level of darkening is greater as compared to the energy savings mode, but still within the capability of the VLTP. A glare reduction algorithm in conjunction with the solar intensity and the outside temperature may be used to seek a balance between the energy savings and glare from the sun and/or privacy. Privacy control, particularly in the daytime by controlling the visible light transmission was discussed earlier (Equation 2). For example, in another mode more than two sensory inputs are used, e.g., the solar light intensity on the window and the ambient outside temperature to kick the window in an energy savings mode whenever a desired combination of the two is achieved. To achieve privacy or glare reduction the user may specifically override the energy savings mode for a certain period. In addition an occupant sensor located in the window scanning the inside of the building or the room in which the window is located, may determine that an occupant is close to the window; and under those circumstances temporarily shifts the window from an energy conservation mode to privacy or glare reduction mode by deepening the tint level. It is important for a self-regulating wireless window that any of the sensors required should either be present in the window (e.g. connected or be a part of the electronic module), or the electronic module must be capable of obtaining this information wirelessly from other sources.

TABLE 6
Exemplary settings/combinations for a self-
regulating window for energy savings

| | | Solar | |
|---|---|---|---|
| | Temperature | Intensity | |
| Setting | (T_{A}) | (W/m²) | Season |
| 1 | 25 | 100 | Summer (≥25° C.) |
| 2 | 15 | 300 | Fall, Spring (>10° C., <25° C.) |
| 3 | 5 | 600 | Winter (≤10° C.) |

Therefore, there may be several modes of self-regulation. In one mode energy-savings plays a dominant role, and as explained one measures the solar intensity on the window and the external temperature for this regulation. Optionally, interior temperature may also be measured. External/exterior refers to outside the building and internal/interior refers to inside the building. Since these windows are located on the building envelope (or building) they form the barrier between the outside, external or exterior to the internal, interior or the inside of the building. Since buildings and rooms may be large or small, “interior” for self-regulating windows refers to an area proximate to the window, e.g., the room in which the window is located. Similarly, exterior refers to an area outside the building proximate to the window, particularly when sensors are located on the window.

One self-regulating mode prioritizes glare reduction. In this mode, either the outside solar intensity or the visible light intensity is measured and certain decisions are made based on the measurement. In some aspects, both of these are labelled as measurement of solar intensity.

Another mode of self-regulation considers both glare reduction and energy savings. In some embodiments, the glare reduction and energy savings considerations are balanced. In another mode, privacy is prioritized, wherein the outside light intensity is measured and the interior lighting is either measured or assumed and then a decision is made to darken the window to an appropriate amount. Furthermore, the privacy settings may be triggered or used with a motion sensor which detects motion in the pre-determined distance range such as proximity to about within 20 yards of the window and outside the building, and in another embodiment this is less than 10 yards.

For the windows which are wireless and are self-regulating, all of the sensors required for self-regulating windows may be present on the window (eWindow, i.e., including the frame and connected to the electronics, as depicted in FIG. 3). Alternatively, the window may be able to obtain the sensory inputs wirelessly from sensors or external to the window or the web/cloud, etc. The sensors on the window may be interior or exterior facing and may include interior light sensors, interior temperature sensors, exterior motion sensors for sensing motion in a pre-determined distance range which may be different for the exterior and the interior sensors.

In another embodiment, multiple self-regulation modes may be available for a window, and the user can make an election on which one to use, override a mode temporarily, or even turn the self-regulation feature off. In one specific embodiment of multiple modes (or factors), different self-regulation factors are used for different windows in the same house/building. For example, windows located in the front entryway may be programmed or elected for privacy self-regulation, while bedroom windows may be programmed for glare and or privacy self-regulation, and all other windows in the building or house may be programmed for energy savings self-regulation, etc. VTWs thus provide an enormous flexibility for self-regulation and optimizing and tailoring the user experience.

Some of these windows may be provided by the manufacturers with specific self-regulating features. For example, for privacy self-regulation, the sensory inputs may be selected from one or more of outside motion detectors, interior occupant detection and the light intensity proximate to the window both outside and inside. For glare control, one may select the solar radiation falling on the window along with occupant detection in the room and take the appropriate action automatically to control the optical transmission in order to overcome the situation. It is to be noted that in networked windows only some of the sensors or none of the sensors and inputs may be present on the windows as some of the sensory inputs may be obtained external to the windows, although solar cells to power the VLTP and for communication will be present on the windows (and/or their frames). In most cases it is desirable to have a mechanism to override the self-regulation at least temporarily and/or be able to adjust the self-regulating parameters to make this product appealing to a wider range of customers and situations. In one embodiment, to conserve power, other than the master window in the cluster, the wireless transmitter of the other windows may be silenced upon receiving an instruction from the master or the user.

The extent of darkening may be dependent on the type of self-regulation being used. For example, when the darkening is caused to save energy, the window only darkens to a minimum VLT (or 550 nm transmission) of about 5 to 10%. This is because below 5 to 10% darkening there is not a significant change in the SHGC, but the transmitted light has a reduced color rendering index (CRI), particularly if the windows darken to a specific color, e.g., to a blue or a green color. Further, darkening to 5 to 10% also minimizes the visual impact of a user as they look through the window from inside the building. In privacy or glare reduction mode the windows may be darkened to the maximum extent required for that setting. In one self-regulation embodiment, wireless communication between the window to the outside world when used in a building is not necessary. In another mode, these may be a limited wireless access via a remote or a phone app for programming the parameters of a given self-regulation mode or to change the type of self-regulation mode, and/or access by a maintenance person for diagnostics when there is a malfunction.

Yet in another embodiment, the self-regulating windows may be further enhanced in their functionality by allowing user control to change the light transmission through the windows using wireless communication. In one embodiment, the user is able to program the settings in Table 6. This could be achieved by a mobile device, such as a remote or a cell phone using e.g., a Bluetooth connection. Each window is labelled numerically or alphanumerically, e.g., 1, 2, 3 . . . , or Kitchen-East, Kitchen North, etc. and the clusters formed and named as needed. This may be done at the time of installation or later during use. Since windows in a building may face different directions and/or are in rooms with different functions, they may have similar or different program settings. The settings on the window may be different if the user feels that they are more adaptive to their needs. An example of the program settings is shown in Table 6. Even with the same settings, the solar intensity falling on the windows can be different and would react differently.

In another embodiment, the user using a mobile/wireless device (e.g., a phone app, remote, etc.), may be allowed additional control for a self-regulating window that is for certain periods overriding the self-regulation mode For example, in one embodiment, when a user activates the window, the user overrides the self-regulating function for a short while to increase the level of opacity (darkness or tint) or to clear (or bleach) it more. More specifically, if the user is working physically close to the window, they could access the window and trigger a glare reduction mode, which would darken the window to about or less than 2% VLT or a transmission set by the user for this mode. At this trigger point, the solar intensity falling on the solar cell/module on the window is recorded. As the sun moves in a different direction, and the intensity on the solar cell diminishes by a certain amount e.g., 20% to 60% from the above recorded solar intensity when the user had perceived an action against the glare, the window will automatically trigger the self-regulating mode, as disclosed earlier.

In another embodiment, the user may trigger a privacy mode which can darken the glass to its darkest state, or in accordance with Equation 2, and may even control a light outside the window, which can be turned on when it is dark outside. To determine the darkening for the privacy mode, according to Equation 2, requires light intensity measurement of the indoor space, which may be from a light sensor on the window that faces inside, or this may be a light sensor on the mobile device (e.g., camera on a cell phone). The solar cell facing outside is used to measure the outside light intensity. The self-regulating mode may automatically kick in after a certain time or if the solar cell senses an outside light intensity in a range of 100 to 300 W/m². The privacy or the darkest the VTW can get to (lowest VLT) may also be put on a schedule by the user, for example, a bedroom window in the morning, or until the time that the battery runs out of power to be able to keep in the window in the desired state. The phone app may also provide an estimate of energy savings and a history of operation to help user further fine tune the parameters. This app may be linked to other energy related apps, such as power consumption pattern over time, peak power curtailment, solar energy and storage, electric vehicle charging, etc., if applicable.

An additional embodiment may permit the self-automation of a VTW which has been programmed to minimize building energy use while also allowing the window to vary its light transmission to provide for glare control, privacy, or other aesthetic preferences. This automated VTW, while not operating in the ‘most energy efficient’ mode, can be named ‘glare mode’, ‘privacy mode’, or ‘custom mode’ as a VTW product seller or user may desire.

In one embodiment of a self-regulating window, no battery is included to power the window. The electronics wakes up only when there is solar power and the windows are able to switch the optical state, i.e., are able to vary the light transmission and wirelessly communicate with each other if networked depending on the algorithm and user desire. Especially when the VLTPs are self-erasing, and in absence of power they all automatically return to their clear state. In the clear state, all VTWs in the building appear uniform and no power is required to maintain this state. On the next day, as the sun rises, they start regulating the solar transmission automatically as prescribed by the user.

To reduce mechanical failures in the window, in one embodiment, there are no switches or a user interface (e.g., a panel for a user to access) on the window. However, there may be indicators, such as LED light(s) showing the window status in different colors when it is in self-regulating mode or there is a malfunction, etc. In those windows, when a user communicates using a wireless device, another LED may illuminate, or the LED may change its color while it is engaged actively by the mobile device to change its program, and/or the window is in privacy or the glare reduction mode, etc. These LEDs may only be turned on for a few minutes when interrogated by the user, or when they are transitioning from one mode to the other. In one embodiment, these may be always on or on for long periods of time, showing that the window is functioning properly and may flicker if it needs maintenance (e.g., battery replacement). The LEDs for indicators consume about 0.01 W of power. This could be reduced by not powering them all the time, as discussed above. It is estimated that in a window a power budget for the LEDs at 0.05 W/sq meter of the window area would be adequate, even if there are a number of LEDs. LEDs will consume the same amount of power/window or node whether they are on a large window or a smaller window, and since many building windows are larger than 1 sq meter, this power budget of 0.05 W/m² is adequate. Accounting for 50% efficiency loss in the electronics, the power estimate for LEDs in a window is about 0.1 W/m².

### Centralized Networks, Energy Saving Estimates and Sizing of Solar Cells and Batteries

Clustering windows to form several local networks by the user was discussed above. In this section, the discussion primarily pertains to the windows or the clusters being connected to centralized networks. As shown in FIG. 3, the eWindow along with the solar cell (“solar panel”) may be a part of a network mesh called eWindow mesh.

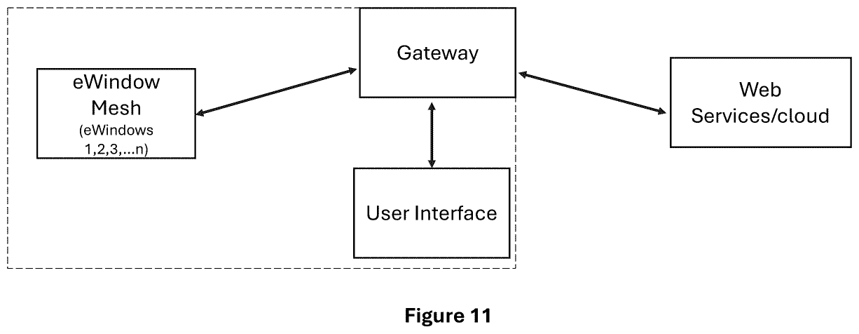

Self-regulating windows may be connected to the remote or the user interface via a gateway, as shown in FIG. 11, by considering the elements in the box with the broken lines only. All of the VTWs, i.e., the nodes, are wirelessly connected to a gateway and may form a mesh type of network. Additional description of the networking and the mesh is provided below. As used herein, “mesh” means that the VTWs are also connected and communicate with each other and the gateway if in range. The user interface connects wirelessly to the gateway (e.g., a phone/computer app, remote, etc., as discussed in the section above), where all of the windows can be addressed or broadcasted to for initially programming the settings or changing them, as discussed above. As a further enhancement to the system, the gateway may be connected to webservices/cloud to obtain information on date, weather, etc. Date information may also be used to determine the seasons. Further, in another configuration, the user interface is through personal digital assistants, such as Alexa® (Amazon Inc.), Google Home® (Alphabet Inc.), etc. In this case, the user interface does not directly connect to the gateway, as shown in FIG. 11, but rather connects to the webservices/cloud wherein the webservices/cloud connects to the gateway (this is not shown in FIG. 11). In one embodiment, there may be no radio transmitter on the windows (or it may be turned-off) and only a receiver is active to receive signals so as to reduce the power required for communication. Since in these windows there could be several settings to continuously address the change in seasons, weather and changes during the day, an AI enabled algorithm could seamlessly learn and refine the window control system to result in outstanding energy savings by taking advantage of the SHGC, which may be varied continuously or in more than two binary steps.

FIG. 12 shows a schematic of an embodiment of how the eWindow along with the solar cell is integrated into a network. In this embodiment, each of the eWindows (or eWindows, along with the solar cell) in a building are tied wirelessly as nodes to a gateway. A gateway is an edge hardware device which is further connected to a local area network. The gateway may also be optionally connected to a building automation system (BAS). The BAS may be the interface between the HVAC system and other sensors and actuators, such as occupancy sensor(s), light sensor(s), etc. There may be several of these sensors in a building, e.g., each room may have a set of these. Application program Interfaces (API) may be used to connect these sensors to the BAS. Some of the companies which supply BAS systems for commercial buildings are Honeywell (Charlotte, NC), Johnson Controls (Milwaukee, MI), Schneider Electric (Andover, MA), and Siemens (St. Paul, MN), and for residential buildings these can be obtained from Google home (and/or NEST™) (Palo Alto, CA), Control4 (Salt Lake City, UT) and Vivint (Provo, UT), etc. The gateway may be connected by wires or wirelessly to a human interface (such as screen, remote, cell phone, etc.).

There may be additional devices and sensors connected directly to the gateway, for example, building security systems, smart locks, cameras, or some of those mentioned earlier that could be connected to the BAS may be connected to the gateway instead. The gateway may also be connected to the utility/web services directly or through another device such as NEST™ HVAC control system from Google. Connection to the electric utility allows the utility to control the optical transmission of the VTWs temporarily to optimize the energy use benefitting both the customers and the electric load on the grid to improve its reliability. The web services may include connections to Web.com, Amazon (Alexa) to obtain weather data, sunrise and sunset times to anticipate and activate the windows in advance to be prepared for the weather, communication with the manufacturer/representative of the VTW windows to provide data on the health of the VTWs and take corrective actions in advance or schedule maintenance.

Based on the outside weather conditions, particularly temperature and solar energy falling on the windows, the building interior temperature set points are used to calculate the amount of energy being saved by only changing its SHGC (since the U value is not impacted by the change in optical transmission of the VTW). This saving in energy is computed in relationship to a window with fixed SHGC, which may be taken as the SHGC of a window typically installed in that region according to the prevailing Energy Star requirements, for example. These calculations may also include total energy saving costs for a consumer, which in addition to the energy savings, may include the reduction of peak loads by using the electronic tinting of the VTWs. As a more specific example, the networked windows may also be in the self-adjusting mode to save energy, as discussed earlier. These may be programmed through the gateway. However, as windows regulate themselves (depending on the outside temperature conditions and the solar intensity falling on them), the instantaneous SHGC is recorded with time along with the solar intensity. The windows are pre-calibrated and depending on the tint of the EC panel in the window, a corresponding SHGC value is obtained. In one embodiment, this information is wirelessly transmitted to the gateway where it assembles this information from various windows of a building. If the VTWs are in an optical state during winter where the SHGC is higher than the fixed value of SHGC in that region, then this means that the difference between the two is the excess energy that is entering into the building and heating the interior. Thus, based on the window area, the amount of this heat is recorded and summed up to see how much energy is being saved in winter. As a specific example, if the solar intensity falling on the window is 400 W/m², the window area is 2 sq meters, and the instantaneous SHGC is 0.30 and the Energy Star calls for an SHGC of 0.23 or lower, the instantaneous energy (IEᵢ) being saved by that window at that time is 56 W (calculated as 400×2×(0.3−0.23)). This number is then collected periodically (Δtᵢ), e.g., in an interval of 15 minutes and summed up over the course of the day, to obtain the energy saving from that window during that day, as shown below by Equation 4. In this case, “i.” represents the number of intervals throughout the day.

$$\sum ( {IE}_{i} \times Δ {t}_{i} ) / \sum ( Δ {t}_{i} ) \qquad ( Equation 4 )$$

Similarly, in summer when the windows are regulated to a SHGC lower than the fixed value of SHGC, that amount of energy difference is the energy that is not entering into the building and does not have to be removed by the air-conditioner, thus saving that net energy. Both in the winter and in the summer this net energy, as calculated from Equation 4, should be adjusted for the efficiency of the heater and the air-conditioner to get the desired energy savings cost. Since the gateway is wired and has the computational and storage power, it is desirable that this information is kept and processed there, and then also transmitted to the BAS/utility company, etc.

The utility/web services node may be a wireless or a wired LAN connection (e.g., Wi-Fi, ethernet, etc.). This node can provide a connection to the utility companies so that they can manage the load on the grid by managing the solar transmission on the windows. For example, in a community or a city having 20 million square feet of window area collectively in a number of buildings, the peak energy savings provided by a grid operator simultaneously dimming each VTW is sufficient to provide grid-level energy savings by reducing HVAC and lighting energy requirements and exceeding savings up to 1 MW and up to multiple GWs of electric utility power capacity. This virtual power plant (VPP) can lessen a utility grid's reliability on fossil fuel-generated electricity while simultaneously avoiding related greenhouse gas emissions. It can also avoid a utility's investment in grid-scale batteries to ‘shave’ electricity peak demand. The utilities may provide a rebate for the user in their monthly billing. In case the utilities hold a mortgage for the installation of these windows then they could adjust the rebate against the mortgage payments.

The eWindow mesh is a collection of several windows (or nodes) where all or many nodes or windows are connected wirelessly to the gateway (the gateway itself is generally wired to the building power). These nodes may also be connected to each other so that if the connection to the gateway for a particular window fails then the network is still viable due to the connectivity between the nodes. Further, if some nodes within the same building are too far from the gateway, they may be connected to the gateway via the other nodes. In other words, the mesh may be a full mesh where every node (including the gateway) is connected to each other directly, or a partial mesh where some nodes, because of logistics and distances, may be connected to only a few nodes, but eventually find their connection to the gateway by hopping through other connected nodes. In this fashion, there is a redundancy in connectivity making the network more stable in case some of the connections get severed.

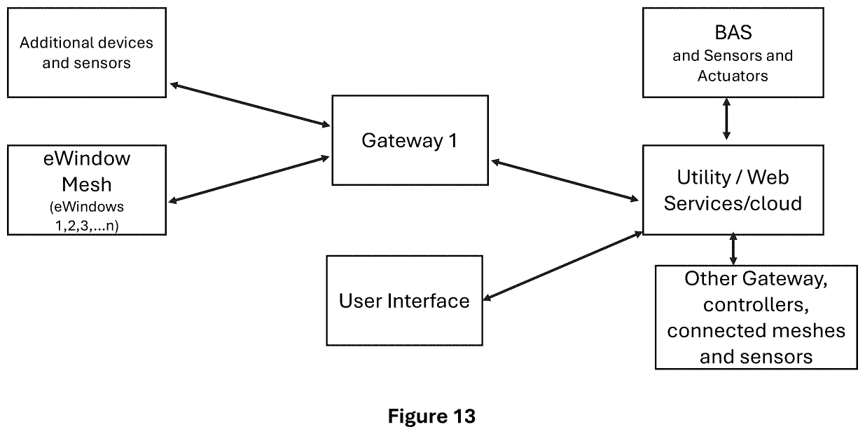

FIG. 13 shows another network configuration where the BAS and certain sensors and actuators connect to it and then it connects to the first gateway (“Gateway 1”) via the cloud/web services. Gateway 1 is analogous to gateway in FIG. 12, which is connected to the eWindow Mesh. Further, there may be certain other systems with one or more additional gateways (Other gateway) connected to additional sensors, meshes (including eWindow meshes). Each gateway may represent different buildings or parts of the same building, such as different tenants, floors, sections, etc. There may be a user interface tied to each gateway, or there may be a universal user (such as the building owner) through the web services/cloud, from which the utilities may also manage the energy usage by the building, including eWindow control.

There are many network protocols, some of which are used in buildings are e.g., Bluetooth, Zigbee, Z-wave, Thread, Matter, etc. Any of these may be selected for the network in FIGS. 12 and 13 where the gateway ties the sensors and the e-window mesh nodes together. Some of the considerations in the choice of the networks are amount of data exchanged, power consumption, physical distance between the nodes, cost, scalability (refers to how many devices can a network handle), the availability of the different kinds of sensors and devices which are compatible within that type of network and security. There are several gateways (or controllers) as shown in FIG. 13, It is usually desirable that the nodes connected wirelessly to a particular gateway should use the same network, e.g., one selected from, Bluetooth, Z-wave, etc. Different gateways may use different wireless networks as long as there is no interreference. In a network, the solar cell on the eWindows may still be used as a sensor to automatically regulate several windows or simultaneously regulate a cluster of windows. In addition, at the time of installation the latitude and the longitude of the building may be obtained from the cloud and supplied to the window electronics so that a self-determination may be made about the climatic zone and the direction of the window facing out (direction of the vector normal to the surface) is entered. This allows the electronics and from the information obtained from the gateway on the sun direction and the weather, so that in some circumstances the windows may start coloration by taking the power from the batteries before the sun is out, and anticipates the sun movement during the day and darken the windows appropriately.

A comparison of some different kinds of networks is provided in Table 6.

TABLE 6
Comparison of wireless technologies

| | | | | | | Bluetooth | | Bluetooth | |
|---|---|---|---|---|---|---|---|---|---|
| Indices | ZigBee | | Z-Wave | | Wi-Fi | (EDR) | | (Mesh) | |
| Power | 100 | mw | 1 | mw | High | 10 | mw | 100 | mW |
| consumption | | | | | | | | | |
| Range | 100 | m | 30 | m | 1000 m | 10 | m | 50 | m |

| Cost | Low | High | Medium | Very low | Very Low |
|---|---|---|---|---|---|
| Scalability | 6000 | >6000 | 32 | 20 | 100 |
| Interoperability | Same | Different | Wi-Fi | Bluetooth | Bluetooth |
| | manufacturer | manufacturers | compatible | compatible | compatible |
| | | | devices | devices | devices |
| Security | High | High | Low | High | High |

For a given network, power consumption of a wireless node given above is generic. For specific cases it depends on many factors, e.g., amount of data being exchanged, number of data/parameters being processed at the node, frequency of data exchange (i.e., how often the data is transmitted), and by the node and latency period, i.e., how quickly do we want the nodes to respond to an instruction from the gateway or the other nodes. In case of the eWindow nodes, the latency period may be long (on the order of a few seconds or even more), and the data exchange is also low (e.g., in the range of 0.5 to 10 bytes) including any security or encryption keys. This is also because the time for response of the current consuming EC panels is several minutes to several tens of minutes, thus for these or even for field devices it is not necessary for the devices to operate at short latency periods. Further, the data exchanged is low as in some cases only a few times a day for activating a window, confirmation from the node, etc. Optionally certain operation parameters from the eWindow may be communicated to the gateway to assess the health of the EC panels. If the energy savings from the windows are being calculated, as discussed earlier, the communication frequency is still low, perhaps only a few times an hour, and that too only when the sun is out and solar cells are producing power in excess of what is needed for powering of the VLTP at that moment. In another power-saving saving embodiment, the nodes (windows) only transmit their status of certain key parameters once a day, which may be recorded several times/day to ascertain the health and functioning of these windows and see if any corrective action/alert is needed. In another embodiment, the radio to the transmitter in the self-regulating products may be turned-off (one-way communication), as was discussed earlier. Therefore, the power required for communication for each node is estimated to be between 1 and 100 mW, where the lower number is when the transmitting radio is turned-off or being used sparingly, and in another embodiment, the power for wireless communication required is about 10 to 100 mW. This power is for each window (or node) rather than on a window area basis. The US Department of Energy has released a document on windows and doors economic analysis which helps us to estimate an average window size in a residential home and also to estimate number of windows (or nodes in this case) in a house based on its square footage. This is shown in Table 7. It is to be noted that not only windows, but also the doors (including sliding doors) may also have IGUs with VLTPs. Thus, the windows include such doors. Larger residences will have more windows, and an average may be calculated from Table 7.

TABLE 7

| | | Window | Window | | |
|---|---|---|---|---|---|
| | Floor | Area | Area | Area per | Number of |
| | Area | (% of Floor | per House | Window | Windows |
| House | (sq. ft.) | Area) | (sq. ft.) | (sq. ft.) | per House |
| 1 | 1700 | 15% | 255 | 15 | 17 |
| 2 | 2,600 | | 390 | | 26 |

Since 15 sq ft is about 1.3 sq meters, an average value of power requirements would be about 8 to 80 mW/m² of window area. Assuming an efficiency loss of 50% in the electronics, this would be 0.016 to 0.16 W/m².

The power consumption of a window on a per square meter basis (of daylight or active area) is estimated by adding the power (a) required to operate the VLTPs which was established to be in a range of 0.2 to 4.8 W/m², (b) indicators if used at 0.1 W/m², and (c) the network communication from 0.016 to 0.16 W/m². Adding all of these together, the wireless VTW power requirement is estimated to be 0.3 to 5.1 W/m². This range of power consumption is used to estimate the solar cell size (area). As can be seen, the most power-hungry aspect of this calculation is the VLTP itself, and even those windows which are self-regulating and not connected to the network will require power in the range of about 0.3 to 4.9 W/m².

Since most of the power is consumed to power the VLTP, the power requirement for this will dominate the battery sizing, particularly at the high-end of the requirement range. As seen from Table 4 and the sizing of the solar cells, under bright conditions sufficient energy is produced for all functions and even more to ensure that the windows are powered appropriately to save energy. The battery and its size are only important if the user desires a privacy mode when there is insufficient solar power to support this. Although the battery sizing is discussed assuming the highest power consumption of about 5 W/m², it is applicable to all windows whether they are networked or not. Considerations for battery size include whether it can provide sufficient boost to augment solar power whenever necessary, whether it is able to color the windows for privacy even when the solar power is not available, whether they should have small format to easily fit in the window frames, whether it is long-lasting, and whether it is easy and economical to replace. To provide a common platform to all the various windows discussed here, any battery may be used that is available to fulfill these requirements. Since battery technology is rapidly evolving, other options may be available in future. For example, currently available lithium-ion batteries, such as industry standard 18650 with a capacity of about 2,000 mAh to 10,000 mAh, and a voltage output of 3.6V, may be used for this purpose. This means that each 1000 mAh is equivalent to 3.6 Wh of power. If the batteries are used for 80% of their capacity and may lose 3-4% of their capacity per year, a conservative assumption will be to assume that about 70% of the battery capacity is available for this function and then they may be replaced several years later. Therefore, a 2,000 mAh battery would provide about 5 Wh energy (3.6*2*0.70=5), and the one with 10,000 mWh would be 5 times as much. Thus, a window with an active area of one square meter could be powered for one hour or five hours respectively with these options after sundown. By increasing the number of batteries in the battery pack, this available power could be changed, which may be desirable for larger windows. As soon as the solar cells start producing power in the morning and regularly throughout the day, the electronics could check the available battery capacity and ensure that if there is any excess power available, the battery is charged to the desired level. In certain embodiments, the battery, VLTP and the network communication, could all be operating simultaneously.

The present disclosure includes the following non-limiting numbered items:
1. A variable optical transmission window for use in a building envelope comprising at least one insulated glass unit (IGU) and a window frame,
   a) wherein the IGU comprises at least one variable light transmission panel (VLTP) configured such that application of electric power to the VLTP activates a change in optical transmission of the VLTP; and
   b) wherein the variable optical transmission window further comprises:
      i) a solar cell and a control system, wherein the electric power for the VLTP to activate the optical transmission change and for the control system is produced by the solar cell;
      ii) wherein the control system is configured to take commands from a user, wherein the commands include self-regulating parameters for self-regulation of optical transmission of light through the variable optical transmission window; and
      iii) wherein optical transmission and a solar heat gain coefficient of the window are configured to self-regulate by responding to at least parameters I and II:
         I) intensity of solar light on the variable optical transmission window; and
         II) ambient temperature outside the building envelope into which the variable optical transmission window is installed.
2. The window of any item or combination of items recited in the present disclosure, wherein a rechargeable battery is connected to the control system.
3. The window of any item or combination of items recited in the present disclosure, wherein the control system is configured to effect self-regulation by responding to at least one additional factor selected from:
   (a) ambient temperature inside the building;
   (b) time of day;
   (b) light intensity inside the building in the proximity of the window;
   (c) motion outside the building in the proximity of the window; and
   (d) occupancy of the building.
4. The window of any item or combination of items recited in the present disclosure, wherein the intensity of the solar light falling on the window is determined by the solar cell.
5. The window of any item or combination of items recited in the present disclosure, wherein the window further comprises a temperature sensor.
6. The window of any item or combination of items recited in the present disclosure, wherein the solar cell is used as the temperature sensor.
7. The window of any item or combination of items recited in the present disclosure, wherein the control system further comprises a wireless communication system.
8. The window of any item or combination of items recited in the present disclosure, wherein the wireless communication system interacts wirelessly with at least one of (a) other self-regulating windows in the same building and (b) a mobile device.
9. The window of any item or combination of items recited in the present disclosure, wherein within a building, more than one window is wirelessly networked to form a cluster of windows which are configured to be triggered simultaneously.
10. The window of any item or combination of items recited in the present disclosure, wherein the wireless communication system further wirelessly communicates with at least one of a building management system (BMS) or a gateway.
11. The window of any item or combination of items recited in the present disclosure, wherein the window is configured for a user to (a) set the self-regulating parameters, and (b) temporarily override the self-regulation to achieve one or more of (i) glare control, (ii) enhance privacy, and (iii) form clusters each having more than one variable optical transmission window.
12. The window of any item or combination of items recited in the present disclosure, wherein the self-regulation reduces energy consumption of the building.
13. The window of any item or combination of items recited in the present disclosure, wherein the BMS or the gateway is connected to at least one of (a) a mobile device of a user, (b) a utility company, (c) a cloud server, (d) a sensor, (e) one or more other windows, and (f) one or more other window clusters in the building.
14. The window of any item or combination of items recited in the present disclosure, wherein the VLTP comprises an electrochromic medium comprising at least one electrochromic dye.
15. The window of any item or combination of items recited in the present disclosure, wherein the VLTP is self-erasing and has a leakage current of 5 to 120 μA/cm².
16. The window of any item or combination of items recited in the present disclosure, wherein a ratio of an area of the solar cell to an active area of the variable optical transmission window is from 0.06% to 17%.
17. The window of any item or combination of items recited in the present disclosure, wherein the solar cell, the control system and any associated components are configured to be replaceable without removing the window from the building envelope.
18. A variable optical transmission window for use in a building envelope comprising at least one insulated glass unit (IGU) and a window frame:
   a) wherein the IGU comprises at least one variable light transmission panel (VLTP), configured such that application of electric power to the VLTP activates a change in optical transmission of the VLTP; and
   b) wherein the variable optical transmission window is wireless and further comprises:
      i) a power source and a control system, wherein the electric power for the VLTP to activate the optical transmission change and for the control system is provided by the power source;
      ii) wherein optical transmission and a solar heat gain coefficient of the variable optical transmission window is configured to self-regulate by responding to at least parameters I and II:
         I) intensity of solar light on the variable optical transmission window; and
         II) ambient temperature outside the building envelope into which the window is installed.
19. The window of any item or combination of items recited in the present disclosure, comprising an electronics module that comprises a wireless communication system.
20. The window of any item or combination of items recited in the present disclosure, wherein the wireless communication system interacts wirelessly with at least one of (a) other self-regulating windows in the same building and (b) a mobile device.
21. The window of any item or combination of items recited in the present disclosure, wherein within a building, more than one window is wirelessly networked to form a cluster of self-regulating windows.
22. The window of any item or combination of items recited in the present disclosure, wherein a change in optical transmission of the window simultaneously triggers a change in optical transmission of all windows in the cluster.
23. The window of any item or combination of items recited in the present disclosure, wherein the power source is a solar cell or a photovoltaic system.
24. The window of any item or combination of items recited in the present disclosure, further comprising a temperature sensor.
25. A variable optical transmission window for use in a building envelope comprising at least one insulated glass unit (IGU) and a window frame,
   wherein the IGU comprises at least one variable light transmission panel (VLTP) containing at least one electrochromic dye, wherein the VLTP is configured such that application of electric power to the VLTP activates a change in optical transmission of the VLTP, and
wherein the variable optical transmission window is wireless and further comprises:
   i) a power source and a control system, wherein the electric power for the VLTP to activate the optical transmission change and for the control system is provided by the power source;
   ii) wherein the variable optical transmission window wirelessly interacts with at least one other self-regulating window within the same building.
26. A self-regulating variable optical transmission window for use in a building envelope, comprising at least one insulated glass unit (IGU), wherein each IGU comprises:
   a) at least one variable light transmission panel (VLTP), wherein a change in optical transmission of the window is activated by applying electric power to the VLTP; and
   b) a window frame present around a perimeter of the IGU, wherein the self-regulating variable optical transmission window
      i) is wireless;
      ii) comprises a solar cell; and
         an electronics module comprising a control system for the VLTP, optionally configured to be controlled by a user; wherein electric power for the VLTP and the electronics module is produced by the solar cell; and
wherein the self-regulating variable optical transmission window is configured to self-regulate by responding to at least factors 1 and 2:
   I) intensity of solar light on the window; and
   II) ambient temperature outside a building envelope into which the self-regulating variable optical transmission window is installed;
and wherein the control system applies the electric power to change optical transmission of the VLTP in response to a desired combination of factors 1 and 2.
27. The window of any item or combination of items recited in the present disclosure, wherein a rechargeable battery is connected to the electronics module.
28. The window of any item or combination of items recited in the present disclosure, wherein self-regulation of the window is achieved by responding to at least one additional factor selected from:
   (a) ambient temperature inside the building;
   (b) light intensity inside the building in the proximity of the window;
   (c) motion outside the building in the proximity of the window; and
   (d) occupancy of the building.
29. The window of any item or combination of items recited in the present disclosure, wherein the intensity of the solar light falling on the window is determined by the solar cell.
30. The window of any item or combination of items recited in the present disclosure, wherein the ambient outside temperature is determined by the solar cell.
31. The window of any item or combination of items recited in the present disclosure, wherein the electronics module further comprises a wireless communication system.
32. The window of any item or combination of items recited in the present disclosure, wherein the wireless communication system provides access to the control system.
33. The window of any item or combination of items recited in the present disclosure, wherein the VLTP is activated when the solar light intensity on the window is about or exceeds 100 W/m².
34. The window of any item or combination of items recited in the present disclosure, wherein the VLTP is activated when the solar light intensity on the window is about or exceeds 200 W/m².
35. The window of any item or combination of items recited in the present disclosure, wherein the user overrides the self-regulation by controlling one or more of the parameters including (a) solar intensity at which the window is activated, and/or (b) outside ambient temperature at which the window is activated.
36. The window of any item or combination of items recited in the present disclosure, wherein the window is configured for a user to override the self-regulation temporarily to achieve one or more of: glare control; privacy; to select a certain level of optical transmission; and/or to reduce and optimize electric load on an electrical grid.
37. The window of any item or combination of items recited in the present disclosure, wherein the ambient temperature outside the building is determined by a temperature sensor located on the window.
38. The window of any item or combination of items recited in the present disclosure, wherein the ambient temperature outside the building is determined based on implied average seasonal temperature, wherein the season is determined from a clock present in the electronics module or in the window.
39. A network comprising a plurality of windows of any item or combination of items recited in the present disclosure.
40. The network of any item or combination of items recited in the present disclosure, wherein the network is configured such that the user interfaces with one or more windows of the network via wireless communication.
41. The network of any item or combination of items recited in the present disclosure, wherein the windows are configured to communicate with each other via a wireless communication system.
42. The network of any item or combination of items recited in the present disclosure, wherein the network further comprises a gateway that communicates with the windows wirelessly.
43. The network of any item or combination of items recited in the present disclosure, wherein the network further comprises one or more additional sensors.
44. The network of any item or combination of items recited in the present disclosure, wherein the one or more sensors are located inside the building, outside the building, within the building HVAC control system, within the building automation system, within a cloud, within an electric utility worldwide web service, within a personal digital assistant; or within a phone app; optionally wherein the sensors are wired or wireless.
45. The network of any item or combination of items recited in the present disclosure, where the additional sensors are selected from indoor light sensors, outdoor light sensors, building and room occupancy sensors, outdoor temperature sensors, and indoor temperature sensors.
46. The network of any item or combination of items recited in the present disclosure, wherein each of the one or more windows in the network communicate one or more of (a) optical status, (b) solar intensity and/or (c) outside ambient temperature periodically to the gateway.
47. The network of any item or combination of items recited in the present disclosure, wherein the gateway uses the communication from the one or more windows in the network to calculate and provide the user with an output comprising energy saving or energy-cost savings realized from the network.
48. A self-regulating variable optical transmission window for use in a building envelope, wherein the window is wireless and comprises at least one insulated glass unit (IGU) and a window frame present around a perimeter of the IGU, and the IGU has at least one variable light transmission panel (VLTP), wherein a change in optical transmission of the window is activated by applying electric power to the VLTP; and wherein:
   (i) the window further contains a solar cell; and an electronics module, wherein the electronics module comprises a control system for controlling the VLTP;
   (ii) the electric power for the VLTP and the electronics module is produced by the solar cell;
   (iii) the window is configured to self-regulate by responding to at least two factors selected from:
      a) intensity of solar light falling on the window,
      b) motion outside of the building and within a predetermined distance to the window;
      c) occupancy of an area of the building within a predetermined distance of the window;
      wherein the control system applies the electric power to change the optical transmission of the VLTP when a desired combination of the at least two factors is reached.
49. The window of any item or combination of items recited in the present disclosure, where the window is configured such that the self-regulation can be temporarily overridden to achieve a different level of optical transmission.
50. The window of any item or combination of items recited in the present disclosure, wherein the control system is user-accessible via wireless communication.
51. A self-regulating variable optical transmission window for use in a building envelope, wherein the window is wireless and comprises at least one insulated glass unit (IGU) and a window frame present around a perimeter of the IGU, and the IGU has at least one variable light transmission panel (VLTP) wherein a change in optical transmission of the window is activated by applying electric power to the VLTP and;
   (i) the window further contains a solar cell; and an electronics module, wherein the electronic module comprises a control system for the VLTP;
   (ii) the electric power for the VLTP and the electronics module is produced by the solar cell;
   (iii) the window is configured to self-regulate by responding to at least two factors selected from:
      a) intensity of solar light falling on the window,
      b) time of day
      c) light intensity inside the building within a predetermined distance to said window;
      d) light intensity outside the building within a predetermined distance to said window
      e) motion outside of the building within a predetermined distance to said window;
      wherein the control system applies the electric power to change the optical transmission of the VLTP when a desired combination of the at least two factors is reached.
52. The window of any item or combination of items recited in the present disclosure, where the window is configured such that the self-regulation can be temporarily overridden for achieving a different level of optical transmission.
53. The window of any item or combination of items recited in the present disclosure, wherein the control system is user-accessible via wireless communication.
54. A variable optical transmission window for use in a building envelope, wherein said window comprises at least one insulated glass unit (IGU) and a window frame present around a perimeter of the IGU, and the IGU has at least one variable light transmission panel (VLTP) wherein a change in optical transmission of the window is activated by applying electric power to the VLTP; and wherein:
   (i) the window further contains a solar cell; and an electronics module, wherein the electronic module includes a control system for the VLTP and a wireless communication system;
   (ii) the electric power for the VLTP and the electronics module is produced by the solar cell;
   (iii) the control system is configured to apply the activating electric power to change the optical transmission of the VLTP; and
   (iv) and the window is part of a network wherein the window forms a node in the network.
55. The window of any item or combination of items recited in the present disclosure, wherein the network comprises more than one node, wherein each node contains a window with at least one VLTP, a solar cell and an electronic module which includes a wireless communication system.
56. A gateway connected wirelessly to the window of any item or combination of items recited in the present disclosure.
57. A user interface connected to the gateway of any item or combination of items recited in the present disclosure.
58. The gateway of any item or combination of items recited in the present disclosure, further connected to at least one of the following:
   (a) a user interface;
   (b) a building automation system;
   (c) sensors selected from at least one of building interior light sensors, building interior occupancy sensors, building exterior motion sensors, building interior temperature sensors, building exterior temperature sensors, and building exterior light sensors;
   (d) a personal digital assistant;
   (e) an electric utility company;
   (f) an internet service including a cloud;
   (g) a phone app; and
   (h) a user interface including wireless remotes.
59. The gateway of any item or combination of items recited in the present disclosure connected to an internet service or cloud server.
60. The gateway of any item or combination of items recited in the present disclosure, wherein the internet service or the cloud server is connected to at least one of:
   (a) one or more other gateways;
   (b) a user interface;
   (c) a building automation system;
   (d) one or more sensors;
   (e) an electric utility company.
61. A network comprising multiple windows of any item or combination of items recited in the present disclosure, wherein the windows in the network communicate one or more of their (a) optical status, (b) solar intensity on the window and (c) the outside ambient temperature periodically to a gateway for the gateway to calculate and output to a user an energy saving or energy-cost savings realized from all of the windows in the network.
62. The network of any item or combination of items recited in the present disclosure, wherein an electric utility company controls transmission of the windows to reduce and optimize electric load on an electrical grid.
63. A variable optical transmission window for use in a building envelope, wherein the window comprises at least one insulated glass unit (IGU) and a window frame present around a perimeter of the IGU, and the IGU has at least one variable light transmission panel (VLTP) wherein a change in optical transmission of the window is activated by applying electric power to the VLTP and wherein:
   (i) the window further comprises a solar cell; and an electronics module, wherein the electronics module includes a control system for the VLTP and a wireless communication system;
   (ii) the electric power for the VLTP and the electronics module is produced by the solar cell;
   (iii) the control system is configured to apply the electric power to change the optical transmission of the VLTP;
   (iv) wherein the window is configured for wireless communication by a user to achieve at least one of the following:
      a) set self-regulation parameters;
      b) temporarily interrupt self-regulation of the window to achieve an optical transmission of the window which is different from the optical transmission in a self-regulating mode.
64. The window of any item or combination of items recited in the present disclosure, wherein the window is configured to change optical transmission in response to user input to achieve at least one of privacy and glare control.
65. The window of any item or combination of items recited in the present disclosure, wherein the window is configured for user-selection of the self-regulating parameters selected from at least one of solar intensity falling on the window and outside ambient temperature.
66. A variable optical transmission window for use in a building envelope, wherein the window comprises at least one insulated glass unit (IGU) and a window frame present around a perimeter of the IGU, and the IGU has at least one variable light transmission panel (VLTP), wherein a change in optical transmission of the window is activated by applying electric power to the VLTP; and wherein:
   (i) the window further contains a solar cell; and an electronics module, wherein the electronics module comprises a control system for the VLTP and a wireless communication system;
   (ii) the electric power for the VLTP and the electronics module is produced by the solar cell;
   (iii) the control system is configured to apply the electric power to change the optical transmission of the VLTP;
   (iv) the window is part of a network wherein the window forms a node in the network,
   (v) wherein the window connects to the network through at least one of another node and a gateway.
67. A variable optical transmission window for use in a building envelope comprising at least one insulated glass unit (IGU) and a window frame,
   wherein the IGU comprises at least one variable light transmission panel (VLTP) having self-erasing property, wherein the VLTP is configured such that application of electric power to the VLTP activates a change in optical transmission of the VLTP such that the variable optical transmission window is self-regulating, and
wherein the variable optical transmission window is wireless and further comprises:
   i) a power source and a control system, wherein the electric power for the VLTP to activate the optical transmission change and for the control system is provided by the power source; and
   ii) a wireless communication system configured such that the variable optical transmission window wirelessly interacts with at least one other self-regulating window within the same building.
68. A variable optical transmission window for use in a building envelope comprising at least one insulated glass unit (IGU) and a window frame,
   wherein the IGU comprises at least one variable light transmission panel (VLTP) having a leakage current in a range of 5 to 120 μA/cm², wherein the VLTP is configured such that application of electric power to the VLTP activates a change in optical transmission of the VLTP such that the variable optical transmission window is self-regulating, and
wherein the variable optical transmission window is wireless and further comprises:
   iii) a power source and a control system, wherein the electric power for the VLTP to activate the optical transmission change and for the control system is provided by the power source;
   iv) a wireless communication system configured such that the variable optical transmission window wirelessly interacts with at least one other self-regulating window within the same building.

The singular forms “a,” “an,” and “the” include plural referents unless the context clearly dictates otherwise.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.01 to 2.0” should be interpreted to include not only the explicitly recited values of about 0.01 to about 2.0, but also include individual values and sub-ranges within the indicated range. Thus, included in this numerical range are individual values such as 0.5, 0.7, and 1.5, and sub-ranges, such as from 0.5 to 1.7, 0.7 to 1.5, and from 1.0 to 1.5, etc. Furthermore, such an interpretation should apply regardless of the breadth of the range or the characteristics being described. Additionally, it is noted that all percentages are in weight, unless specified otherwise.

In understanding the scope of the present disclosure, the terms “including” or “comprising” and their derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings, such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps, as well as those that do not materially affect the basic and novel characteristic(s) of features, elements, components, groups, integers, and/or steps. It is understood that reference to any one of these transition terms (i.e. “comprising,” “consisting,” or “consisting essentially”) provides direct support for replacement to any of the other transition terms not specifically used. For example, amending a term from “comprising” to “consisting essentially of” would find direct support due to this definition.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. For example, in one aspect, the degree of flexibility can be within about ±10% of the numerical value. In another aspect, the degree of flexibility can be within about ±5% of the numerical value. In a further aspect, the degree of flexibility can be within about ±2%, ±1%, or ±0.05%, of the numerical value.

Generally, herein, the term “or” includes “and/or.”

As used herein, a plurality of compounds or steps may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, certain compositions, injuries or conditions, steps, or the like may be discussed in the context of one specific embodiment or aspect. It is understood that this is merely for convenience, and such disclosure is equally applicable to other embodiments and aspects found herein.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

What is claimed is:

1. A variable optical transmission window for use in a building envelope comprising at least one insulated glass unit (IGU) and a window frame,
a) wherein the IGU comprises at least one variable light transmission panel (VLTP) configured such that application of electric power to the VLTP activates a change in optical transmission of the VLTP; and
b) wherein the variable optical transmission window further comprises:
i) a solar cell and a control system, wherein the electric power for the VLTP to activate the optical transmission change and for the control system is produced by the solar cell;
ii) wherein the control system is configured to take commands from a user, wherein the commands include self-regulating parameters for self-regulation of optical transmission of light through the variable optical transmission window; and
iii) wherein optical transmission and a solar heat gain coefficient of the window are configured to self-regulate by responding to at least parameters I and II:
I) intensity of solar light on the variable optical transmission window; and
II) ambient temperature outside the building envelope into which the variable optical transmission window is installed.

2. The window of claim 1, wherein a rechargeable battery is connected to the control system.

3. The window of claim 1, wherein the control system is configured to effect self-regulation by responding to at least one additional factor selected from:
(a) ambient temperature inside the building;
(b) time of day;
(b) light intensity inside the building;
(c) motion outside the building within 20 yards of the window; and
(d) occupancy of the building.

4. The window of claim 1, wherein the intensity of the solar light falling on the window is determined by the solar cell.

5. The window of claim 4, wherein the window further comprises a temperature sensor.

6. The window of claim 5, wherein the solar cell is used as the temperature sensor.

7. The window of claim 1, wherein the control system further comprises a wireless communication system.

8. The window of claim 7, wherein the wireless communication system interacts wirelessly with at least one of (a) other self-regulating windows in the same building and (b) a mobile device.

9. The window of claim 8, wherein within a building, more than one window is wirelessly networked to form a cluster of windows which are configured to be triggered simultaneously.

10. The window of claim 7, wherein the wireless communication system further wirelessly communicates with at least one of a building management system (BMS) or a gateway.

11. The window of claim 1, wherein the window is configured for a user to (a) set the self-regulating parameters, and (b) temporarily override the self-regulation to achieve one or more of (i) glare control, (ii) enhance privacy, (iii) form clusters each having more than one variable optical transmission window.

12. The window of claim 1, wherein the self-regulation reduces energy consumption of the building.

13. The window of claim 10, wherein the BMS or the gateway is connected to at least one of (a) a mobile device of a user, (b) a utility company, (c) a cloud server, (d) a sensor, (e) one or more other windows, and (f) one or more other window clusters in the building.

14. The window of claim 1, wherein the VLTP comprises an electrochromic medium comprising at least one electrochromic dye.

15. The window of claim 1, wherein the VLTP is self-erasing and has a leakage current of 5 to 120 μA/cm².

16. The window of claim 1, wherein a ratio of an area of the solar cell to an active area of the variable optical transmission window is from 0.06% to 17%.

17. The window of claim 1, wherein the solar cell, the control system and any associated components are configured to be replaceable without removing the window from the building envelope.

18. A variable optical transmission window for use in a building envelope comprising at least one insulated glass unit (IGU) and a window frame:
a) wherein the IGU comprises at least one variable light transmission panel (VLTP), configured such that application of electric power to the VLTP activates a change in optical transmission of the VLTP; and
b) wherein the variable optical transmission window is wireless and further comprises:
i) a power source and a control system, wherein the electric power for the VLTP to activate the optical transmission change and for the control system is provided by the power source;
ii) wherein optical transmission and a solar heat gain coefficient of the variable optical transmission window is configured to self-regulate by responding to at least parameters I and II:
I) intensity of solar light on the variable optical transmission window; and
II) ambient temperature outside the building envelope into which the window is installed.

19. The window of claim 18, comprising an electronics module that comprises a wireless communication system.

20. The window of claim 19, wherein the wireless communication system interacts wirelessly with at least one of (a) other self-regulating windows in the same building and (b) a mobile device.

21. The window of claim 20, wherein within a building, more than one window is wirelessly networked to form a cluster of self-regulating windows.

22. The window of claim 21, wherein a change in optical transmission of the window simultaneously triggers a change in optical transmission of all windows in the cluster.

23. The window of claim 19, wherein the power source is a solar cell or a photovoltaic system.

24. The window of claim 19, further comprising a temperature sensor.

25. A variable optical transmission window for use in a building envelope comprising at least one insulated glass unit (IGU) and a window frame,
wherein the IGU comprises at least one variable light transmission panel (VLTP) containing at least one electrochromic dye, wherein the VLTP is configured such that application of electric power to the VLTP activates a change in optical transmission of the VLTP such that the variable optical transmission window is self-regulating, and
wherein the variable optical transmission window is wireless and further comprises:
i) a power source and a control system, wherein the electric power for the VLTP to activate the optical transmission change and for the control system is provided by the power source;
ii) wherein the variable optical transmission window wirelessly interacts with at least one other self-regulating window within the same building.
